(19) United States
(12) Patent Application Publication
(10) Pub. No.: US 2025/0332725 A1
(43) Pub. Date: Oct. 30, 2025

(54) ROBOT MOTION GENERATION ON ENHANCED COMPUTER PROCESSORS

(71) Applicant: NVIDIA Corp., Santa Clara, CA (US)

(72) Inventors: Siva Kumar Sastry Hari, Sunnyvale, CA (US); Balakumar Sundaralingam, San Jose, CA (US)

(73) Assignee: NVIDIA Corp., Santa Clara, CA (US)

(21) Appl. No.: 18/646,456

(22) Filed: Apr. 25, 2024

(51) Int. Cl. B25J 9/16

(52) U.S. Cl. CPC B25J 9/1666; B25J 9/161; B25J 9/163

(57) ABSTRACT

Processors configured to execute instructions to enable more efficient computation of distances, collisions, and other common engineering tasks, including instructions to share register values among threads executing in a partition of the processor, instructions to compute a distance between surfaces of a sphere, and instructions to obtain identifiers of threads associated with minimal or maximal values of local registers.

### BACKGROUND

Performing collision-free motion path generation is an important task in various contexts such as robotics. However, conventional motion path generation mechanisms may not satisfy criteria for performance, accuracy, and/or the efficient utilization of computing resources.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an example of a machine processor instruction.

FIG. 2 depicts an exemplary robotic system.

FIG. 3 depicts an example of a spherical approximation model for a robotic manipulator.

FIG. 4 depicts a motion planning process for a robotic manipulator in one embodiment.

FIG. 5 depicts a motion planning algorithm for a robotic manipulator in one embodiment.

FIG. 6 depicts additional aspects of a motion planning process for a robotic manipulator in accordance with one embodiment.

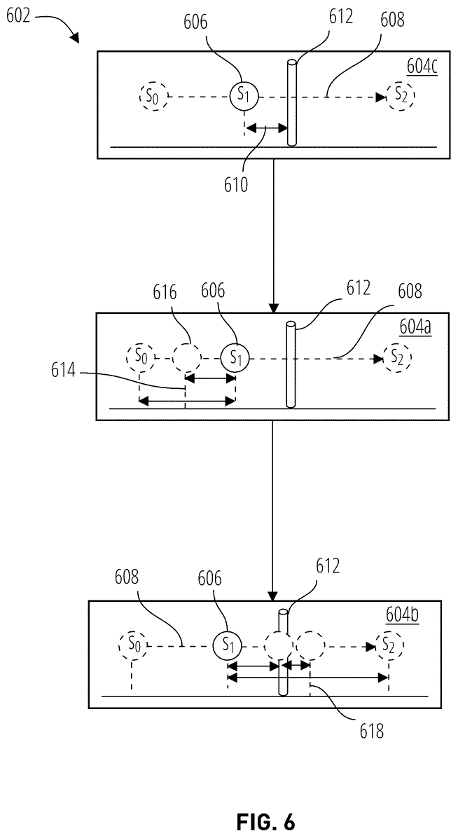

FIG. 7 depicts aspects of a self-collision evaluation for a spherical approximation model of a robotic manipulator in one embodiment.

FIG. 8 depicts exemplary logic to implement a register sharing instruction.

FIG. 9 depicts aspects of a world-collision evaluation for a spherical approximation model of a robotic manipulator in one embodiment.

FIG. 10 depicts a parallel processing unit 1002 in accordance with one embodiment.

FIG. 11 depicts a general processing cluster 1100 in accordance with one embodiment.

FIG. 12 depicts a memory partition unit 1200 in accordance with one embodiment.

FIG. 13 depicts a streaming multiprocessor 1300 in accordance with one embodiment.

FIG. 14 depicts a processing system 1400 in accordance with one embodiment.

FIG. 15 depicts an exemplary processing system 1500 in accordance with another embodiment.

FIG. 16 depicts a graphics processing pipeline 1600 in accordance with one embodiment.

### DETAILED DESCRIPTION

Disclosed herein are embodiments of mechanisms to accelerate collision checking on a computer processor, such as for example a graphics processing unit (GPU) or central processing unit (CPU) or a machine controller chip. The mechanisms may be applied for example to improve the execution speed and efficiency of collision detection between spheres and between spheres and bounding boxes. One application of these mechanisms is for self-collision and world collision detection to accelerate robot manipulator path planning, for example in applications where a robot's motion is not pre-programmed so that fast, ad hoc motion generation is called for.

Another example of an application that may benefit from the disclosed collision detection mechanisms is path planning for autonomous or semi-autonomous vehicle operation. Generally, it is beneficial to improve the execution speed and efficiency of common operations such as distance calculations and point manipulation that are utilized in a wide range of engineering and other applications. Exemplary embodiments described herein relate to robotic path planning, however the disclosed mechanisms have broader applicability.

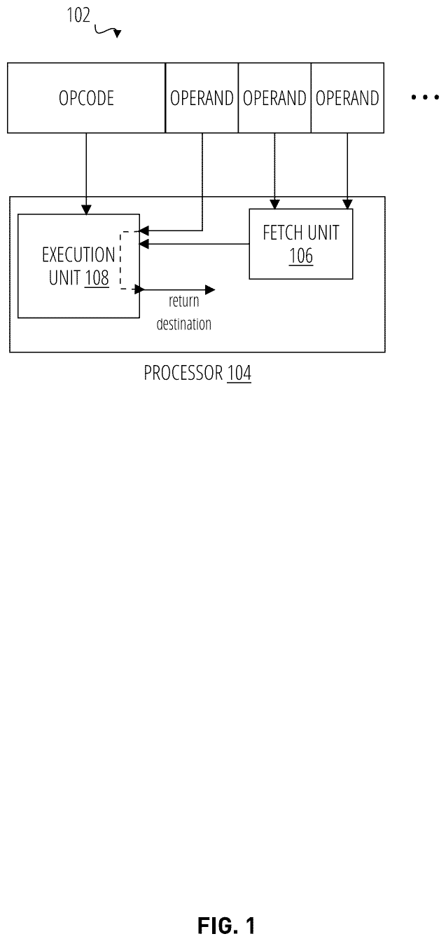

FIG. 1 depicts an instruction 102 applied to control the operation of a computer processor 104. The instruction 102 comprises an operation code (opcode) and (optionally, depending on the opcode) one or more operands. The opcode specifies the operation for the execution unit 108 of processor 104 to carry out. One or more of the operands may specify source locations of data to operate on, or control settings or characteristics (e.g., formatting) of the data to operate on. The source operands may be applied to a fetch unit 106 of the processor 104 for retrieval of values from registers or other locations in machine memory (cache, bulk main memory, etc.). One or more of the operands may specify a destination location for returning results on executing the opcode operation on the source operands.

An instruction may be understood as a specific physical arrangement of control signals to apply to a processor in a computing system, with the processor being specifically configured to respond to this arrangement of signals to execute the opcode (optionally, using the one or more operands). The specific implementation of an instruction within a particular processor type and model may vary according to the processor utilized, but generally involves techniques and logic (e.g., gates, busses, memories, pipelines, buffers, microcode, etc.) that are well known in the art or readily ascertainable by those of ordinary skill in the art without undue experimentation.

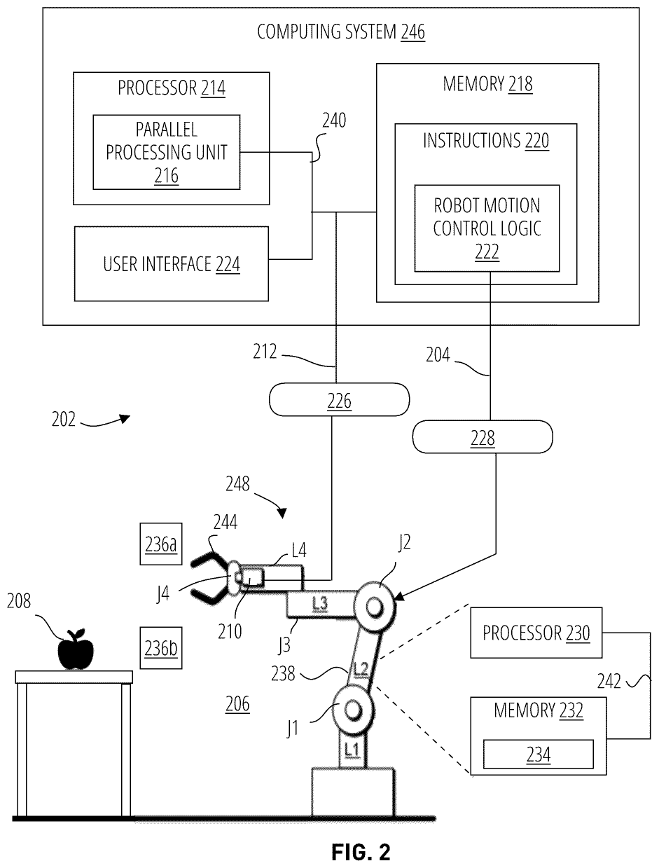

FIG. 2 is a block diagram depiction of an exemplary robotic system 202. The robotic system 202 includes a computing system 246 in communication with a manipulator 248. The manipulator 248 may comprise a robot, robotic component, robotic end-effector (e.g., gripper), and/or variations thereof, and logic to enable the manipulations of objects 208 (e.g., grabbing objects, moving objects, placing objects, and/or variations thereof).

The computing system 246 may be a component of the manipulator 248 or vice versa. The computing system 246 may interface to the manipulator 248 by a wired and/or wireless communication interface 204. The robotic system 202 may be deployed in various environments such as factories, healthcare (e.g., hospitals), offices, households, simulated virtual environments, and/or any suitable hosting environment where manipulation of objects is carried out.

The manipulator 248 may be implemented for example as an autonomous machine, a semi-autonomous machine, or in a command/control configuration. The manipulator 248 operates within an environment 206 under certain motion constraints. In the embodiment illustrated in FIG. 2, the manipulator 248 comprises an arm 238 including a gripping end effector 244. The manipulator 248 comprises one or more links L1-L4 and joints J1-J4. The manipulator 248 may be configured to avoid one or more obstacles 236a, 236b within the environment 206 while traversing a trajectory to grip and manipulate the object 208.

One or more sensors 210 may be positioned to monitor the manipulator 248, the environment 206, and/or the objects 208 to generate sensor data 226. The sensors 210 may be implemented as image capture device(s), motion sensor(s), pressure sensor(s), and/or the like. In the embodiment depicted, the sensor(s) 114 are implemented as an image capture device (e.g., a camera, a video camera, a depth video camera, and/or the like) that captures red, green, blue-depth (“RGB-D”) image data. In at least one embodiment, the computing system 246 may be communicatively coupled to the sensors 210 by a wired and/or wireless sensor interface 212.

The computing system 246 may include memory 218, one or more processors 214, and a user interface 224. The memory 218 (e.g., one or more non-transitory processor-readable medium) may store processor executable instructions 220 that when executed by the processor 214 implement robot motion control logic 222.

The memory 218 (e.g., one or more processor-readable medium) may be implemented, for example, using volatile memory (e.g., dynamic random-access memory (“DRAM”)) and/or nonvolatile memory (e.g., a hard drive, a solid-state device (“SSD”), and/or the like). The processor 214 (which may comprise multiple processing cores or distinct processor packages) may include one or more circuits that perform at least a portion of the instructions 220 stored in the memory 218. The processor 214 may include one or more parallel processing units 216, such as one or more graphics processing units (“GPU(s)”), one or more massively parallel GPU(s), and/or the like.

In at least one embodiment, massively parallel GPU(s) refer to a collection of one or more GPUs, or any suitable processing units, which may be utilized to execute workloads in parallel. The processor 214 may be implemented, for example, using a main central processing unit (“CPU”) complex, one or more microprocessors, one or more microcontrollers, one or more GPU(s), one or more data processing units (“DPU(s)”), one or more arithmetic logic units (“ALU(s)”), and combinations of these components.

The user interface 224 may include a display device (not depicted) that a user may use to view information generated and/or displayed by the computing system 246. The user may interact with the user interface 224 to enter user input into the computing system 246. The processor 214, the user interface 224, and/or the memory 218 may communicate with one other and with other common computer system components (not depicted) over one or more communication interface 240, such as a bus, a Peripheral Component Interconnect Express (“PCIe”) connection (or bus), and/or the like.

The robot motion control logic 222, when applied from the memory 218 to be executed by the processor 214, may configure the computing system 246 to perform motion planning and generate a trajectory or motion plan for the manipulator 248. The robot motion control logic 222 may be implemented as a library, an Application Programming Interface (“API”), a GPU accelerated library, and/or in other manners known in the art. The robot motion control logic 222 may comprise one or more processes, algorithms, data, functions, subroutines, and the like to implement or otherwise perform the motion planning. In one embodiment the robot motion control logic 222 implements parallel processing unit 216-accelerated robot motion generation algorithms (e.g., utilizing hardware support (e.g., processors enhanced to execute certain instructions) for mathematical computations particularly critical to performance of the motion planning.

In some embodiments, the manipulator 248 itself may include one or more processors 230 coupled over a communication interface 242 to one or more memory 232 comprising instructions 234. These components may be implemented in manners similar to those described above for the computing system 246. Some or all of the robot motion control logic 222 may be implemented by the instructions 234 of the manipulator 248, as determined by the particular implementation of the robotic system 202. Some or all of instructions 228 from the robot motion control logic 222 may be provided from the computing system 246 to the manipulator 248 for execution locally by the processor 230 of the manipulator 248.

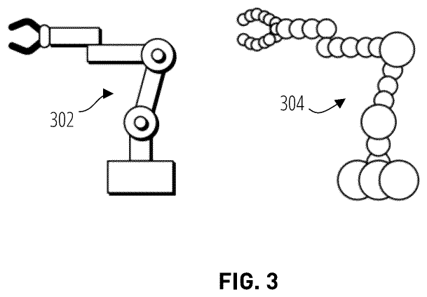

FIG. 3 depicts robotic manipulator 302 alongside an example spherical approximation model 304. Representing the robotic manipulator 302 as a set of spheres enables faster and more efficient collision checking. A sphere generator (e.g., Lula Robot Description Editor) may for example be utilized to generate the spherical approximation model 304.

To perform collision checking between the robotic manipulator 302 and itself, a distance between the surfaces of the spheres at various time steps may be computed efficiently utilizing the mechanisms disclosed herein. For collision checking between the robotic manipulator 302 and objects in its environment, a distance between the surfaces of the spheres and bounding boxes of the external objects may be computed efficiently utilizing the mechanisms disclosed herein.

More specifically, for self-collision avoidance, the path planning algorithms for the robotic manipulator 302 may compute a distance between each pair of spheres (e.g., compute a point distance between the centers of the spheres and subtract the radii of the two spheres) and apply this distance to evaluate motion scenarios.

Kinematics logic may be engaged to map the joint configuration of the robotic manipulator 302 to world coordinates for configurations (poses) of the spheres. The kinematics may provide task space poses for any of the links L1-L4 (see FIG. 2) that are applied to compute costs for candidate motion paths.

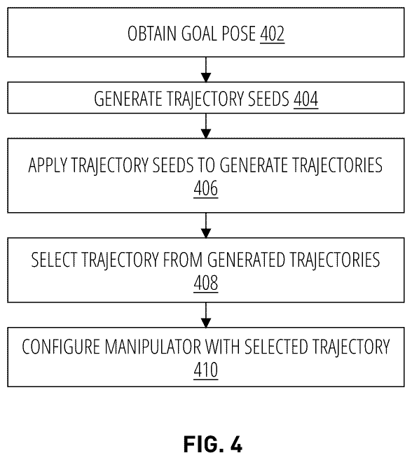

FIG. 4 depicts, at a high level, an example routine for configuring a robotic manipulator trajectory. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

A goal pose is obtained (block 402) and trajectory seeds are generated for the goal pose (block 404). The trajectory seeds are applied to generate candidate trajectories (block 406) and one of the candidate trajectories (a collision-free trajectory) is selected (block 408) to configure the manipulator (block 410).

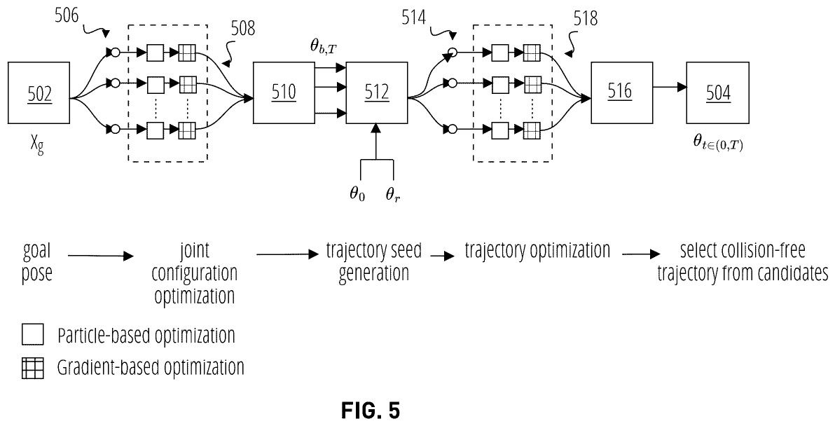

FIG. 5 depicts an embodiment of an algorithm to generate a trajectory for an end-effector (e.g., a gripper or other tool) of a robotic manipulator in a goal pose 502 (e.g., represented by the variable X_{g}). The algorithm transforms the goal pose 502 into a collision-free trajectory 504 for the end effector. The goal pose 502 for example may be a configuration in which the end-effector grips or otherwise manipulates or works on an object. The goal pose 502 may originate as an input from a user interface or as input from another process (e.g., auto-generated in a simulation).

From the goal pose 502, one or more goal joint configurations may be determined that each position the end-effector in the goal pose 502. Inverse kinematics (“IK”) may be utilized to generate a number of seeds 506 from the goal pose 502. The seeds 506 may be transformed by logic implementing optimizers 508 into candidate joint configurations 510 (0b,T).

On multiprocessor/multi-threaded computing platforms, the optimizers 508 may operate in parallel and iteratively until a configured stopping condition is reached, such as the task cost (calculated by a cost function) satisfying a threshold value or a predetermined number of iterations having been performed. Each of the candidate joint configurations 510 represents a joint configuration that positions the end-effector in the goal pose 502.

Some types of optimizers 508 that may be utilized include: sampling-based optimizations, gradient-free optimizations; and gradient-based optimizations (e.g., one or more optimizations based on a Limited-memory Broyden-Fletcher-Goldfarb-Shanno (“L-BFGS”) algorithm). For example, the optimizers 508 may comprise particle-based optimization on the seeds 506 followed by L-BFGS optimization performed on the output of the particle-based optimizations. In one embodiment, L-BFGS optimization may be performed by a GPU batched L-BFGS optimizer applying an approximate parallel line search mechanism.

The candidate joint configuration 510 are provided by optimizers 508 to the path planner 512. The path planner 512 utilizes the candidate joint configuration 510, the manipulator's initial joint configuration (θ₀), and the manipulator's retract joint configuration (θᵣ) to determine trajectory seeds 514. The initial joint configuration may be input from the system user or read from the sensors of the manipulator, for example.

The path planner 512 may in one embodiment implement global and geometric trajectory planning. The global planner may generate trajectory seeds 514 in parallel by interpolating from the initial joint configuration to each of the candidate joint configurations 510. The geometric planner may generate trajectory seeds 514 using geometric planning (instead of interpolation) to produce one or more collision-free geometric paths or trajectories in parallel. The geometric planner may have particular utility for path planning problems that are difficult to solve globally.

For example, in some embodiments, the global planner may initially attempt to generate suitable trajectory seeds 514, but if some or all of these are determined to be unsuitable, the geometric planner may be invoked to generate replacement trajectory seeds 514. In some embodiments, the global planner may be invoked for a configured number of iterations before the geometric planner is invoked.

The retract joint configurations may be computed algorithmically in known manners, or received as user input. The manipulator may retract after grasping the object to a pose comprising the retract joint configuration. In one embodiment, the retract trajectory is appended to the trajectory seed. The global planner may generate the retract trajectory for each of one or more of the trajectory seeds 514 by interpolating from a goal joint configuration of the trajectory seed (e.g., the inverse kinematic solution used to generate the trajectory seed) to the retract joint configuration. The geometric planner may generate the retract trajectory for each of at least a portion of the trajectory seeds 514.

The geometric planner may generate a collision-free path from the initial joint configuration to a final joint configuration (e.g., represented by a variable θ_{T}). The generated path may be specified by a number (e.g., represented by a variable w) of waypoints (e.g., represented by a variable θ_{[0,w]}) through which the manipulator passes along a trajectory.

The geometric planner may utilize a parallel steering algorithm to generate collision-free paths. To leverage parallel computing, the geometric planner may steer a trajectory from a number (e.g., represented by a variable s) of vertices (e.g., represented by a variable θ_{s, 0}) in a graph using the number of sampled new joint configurations (e.g., represented by a variable θ_{s, k}). The graph may comprise a different axis for each of the joints (e.g., J1-J4 in FIG. 2) that measures joint angle. The vertices (or nodes) may each represent an initial joint configuration and each of the new joint configurations may be one of the candidate joint configuration 510 (e.g., a goal joint configuration). Thus, the geometric planner may steer trajectory seeds from the starting joint configuration to one of the candidate joint configurations 510.

Alternatively, the geometric planner may steer from one of the candidate joint configurations 510 to the initial joint configuration, from one of the candidate joint configurations 510 to the retract joint configuration, from the retract joint configuration to one of the IK solutions candidate joint configurations 510, from the initial joint configuration to the retract joint configuration, and/or from the retract joint configuration to the initial joint configuration.

Algorithm 1 below depicts an exemplary process to determine collision-free edges and/or a waypoints in parallel. In Algorithm 1, the geometric planner determines a maximum distance n between the starting joint configuration and the new joint configuration. The geometric planner generates a number of candidate edges to candidate vertices that extend a set of distances from the starting joint configuration toward the new joint configuration. The number of candidate edges and their distances may be determined based at least in part on the maximum distance. The geometric planner checks that the candidate edges are valid and checks for collisions along the candidate edges. The geometric planner adds to the graph the last valid edge without a collision (e.g., the valid collision-free edge that extends the farthest from the starting joint configuration) and a new waypoint terminating last valid edge. In this manner Algorithm 1 may be characterized as identifying collision-free path segments.

Algorithm 1: Parallel Steering

```
  Input: = [θ_{s,0}, θ_{s,k}]
  Parameters: r, d_{w}
```

| | |
|---|---|
| 1. \vec{g} ← distvec [θ_{s,0}, θ_{s,k}] | distance between nodes |
| 2. n ← max (\|\vec{g}\|/r) + 1 | find largest distance |
| 3. \vec{d} ← d[: n + 1]/n | discretize based on largest distance |
| 4. \vec{l} ← θ_{s,0} -\| \vec{d} \vec{* g}/d_{w} | get discretized edges |
| $5. mask ← mask\_samples ( \vec{l} )$ | check for validity |
| 6. h ← first_false(mask) − 1 | first collision index/edge |
| 7. h[h = = − 1] ← n | |
| 8. v_{new} ← l/h] | \|store last valid point/edge |
| 9. d ← dist(θ_{s,0}, v_{new}) | store distance value in edge |
| 10 graph_add (θ_{b,0}, v_{new}, d) | |

Another embodiment of the geometric planner may be implemented in accordance with Algorithm 2 below. The geometric planner may determine whether to steer from the initial joint configuration to the goal joint configuration directly or through the predefined retract joint configuration without encountering a collision. In Algorithm 2, the function “steer_connect(e)” invokes Algorithm 1.

If the heuristic planning fails, the geometric planner may sample collision-free configurations (e.g., represented by a variable v_{new}) from an informed search region (e.g., of the graph) that is within a distance (e.g., represented by a variable cₘₐₓ) of a straight line distance between the initial joint configuration to the goal joint configuration (line 11 of Algorithm 2). The geometric planner may then calculate kₙ nearest neighbors from the graph and attempt to steer from the graph nodes (e.g., the starting joint configurations) toward the new vertices (e.g., the kₙ nearest neighbors)—lines 12 and 13 of an Algorithm 2. The geometric planner may iterate these actions until a path with only one waypoint is determined.

Between attempts, the geometric planner may increase a number of sampled nodes pₙ, the number of nearest neighbors kₙ, and/or the search region cₘₐₓ to expand or otherwise grow the exploration space—lines 19-21 of an Algorithm 2. The geometric planner invokes the function denoted as “shortcut_path( )” to identify a shortest path by connecting the waypoints to construct candidate paths between the starting and new joint configurations, and calculating total distances along the candidate paths.

Algorithm 2: Parallel Geometric Planner

```
  Data: θ_{b,0}, θ_{b,g}
  Param: gₘₐₓ, g_{refine}, cₘₐₓ, c_{default}, k_{refine}, kₑₓₚₗₒᵣₑ, pᵢₙᵢₜ, p_{refine}, pₑₓₚₗₒᵣₑ
  Result: path_found, pathΘ_{b,[0,w]})
1. Init: kₙ ← kₑₓₚₗₒᵣₑ, cₘₐₓ ← c_{default}, pₙ ← pₑₓₚₗₒᵣₑ, i ← 0
$2. e = [ [ {θ}_{b , 0} , {θ}_{b , g} ] , [ {θ}_{b , g} , {θ}_{b , 0} ] , [ {θ}_{b , 0} , {θ}_{r} ] , [ {θ}_{r} , {θ}_{b , 0} ] , [ {θ}_{b , g} , {θ}_{r} ] , [ {θ}_{r} , {θ}_{b , g} ] ]$
3. steer_connect(e) [symbol]   connect start, goal and retract
4. path_found, path, min_len ← shortest_path (θ_{b,0}, θ_{b,g})
5. if path_found then
6. path, min_len, cₘₐₓ ← shortcut [symbol]   path (θ_{b,0}, θ_{b,g})
7. if min_len = = 2then return path
8. end
9. cₘᵢₙ ← dist(θ_{b,0}, θ_{b,g})
10. while not path_found or < g_{refine} do
11. id ← random(1path _ found) Pick an index from the set of queries
that do not have a path yet
12. θ_{s,k} ← sample_nodes(θ₀, θ_{g}, cₘₐₓ, pₙ) sample nodes within ellipse
13. e ← near (kₙ, θ_{s,k}) Find kₙ nearest samples θ_{s,k} to existing nodes
in graph
14. steer_connect(e) Steer and connect to graph
15. path_found, path, min_len ← shortest_path (θ_{b,0}, θ_{b,g})
16. i+ =1
17. if path_found && min_len > 3 then
18. path, min_len, cₘₐₓ ← shortcut _ path(path)
19. else
20. cₘₐₓ [id] ← cₘₐₓ [id] + cₘᵢₙ[id]*ηₑₓₚₗₒᵣₑ
21. pₙ + = ηₑₓₚₗₒᵣₑ* pₙ
22. kₙ + = ηₑₓₚₗₒᵣₑ * kₙ
23. end
24. end
25. return path_found, path
```

The geometric planner may identify at least one collision fee path segment by searching, in parallel, along directions between the vertices of the starting joint configurations and target points of the candidate joint configurations 510. The geometric planner thereby generates a collision-free trajectory for the manipulator by selecting one or more edges from the graph that interconnect a starting point in the graph to a target point in the graph.

The system may limit candidate trajectories 516 to those for which the transition states between the initial joint configuration and the final joint configuration satisfy certain constraints. The goal pose (represented by the variable X_{g}) may be defined within Cartesian space and an expression [symbol] (3) may represent a set of potential poses of the manipulator, such that X_{g}∈ [symbol] (3). The candidate trajectories 516 may satisfy constraints on position, velocity, and/or acceleration of the manipulator, as well as requiring that the manipulator does not collide with itself or objects in the environment.

Trajectory optimizations 518 may be performed on the trajectory seeds 514 to generate a number of candidate trajectories 516. The trajectory optimization 518 may be calculated iteratively until a configured stopping condition is reached, such as the task cost (calculated by a cost function) satisfying a threshold value or a predetermined number of iterations having been performed. A collision-free trajectory 504 (e.g., represented by the variable θ_{t∈[0,T]}) is selected from the candidate trajectories 516 based on one or more configured settings for preferred trajectory characteristics.

The robot motion control logic 222 may utilize a time discretized trajectory optimization model to select the collision-free trajectory 504 as follows, although variations thereof may also be utilized:

${arg min}_{{θ}_{[ 1 , T ]}} {( {X}_{g} - {K}_{e} ( {θ}_{T} ) )}_{2} + {{\sum }^{T}}_{t = 1} {{γ}_{1} ( {\ddot{θ}}_{t} )}_{2}$
C_{w}(Kₛ (θₜ)) ≤ 0, ∀t ∈ [1, T]
Cᵣ(Kₛ(θₜ)) ≤ 0, ∀t ∈ [1, T]
θ⁻ ≤ θₜ ≤ θ⁺, ∀t ∈ [1,T]
\dot{θ}⁻ ≤ \dot{θ}ₜ ≤ \dot{θ}⁺, ∀t ∈ [1, T]
\ddot{θ}⁻ ≤ \ddot{θ}ₜ, ≤ \ddot{θ}⁺, ∀t ∈ [1,T]
\dot{θ}_{T} = 0

The model may utilize a kinematic function Kₑ(•) to determine a pose of the end-effector given a joint configuration (represented by a variable θ). A kinematic function Kₛ(•) computes a location of spheres that fill a volume of the manipulator. The spheres may be used to check collisions with the world or the environment (represented by a collision function C_{w}(•)) and with the manipulator itself (represented by a collision function Cᵣ(•)). The collision functions (C_{w}(•), Cᵣ(•)) may each return a distance to a closest obstacle. A joint velocity \dot{θ} and a joint acceleration \dot{θ} may be determined using a finite difference method (e.g., central difference). The term ((X_{g}−Kₑ(θ_{T}))₂) represents a pose cost. The cost terms and constraints applied may be any suitable values, functions, and/or variations thereof, and may be calculated through any suitable process, function, heuristics, and/or variations thereof, such as those described herein or by others known in the art.

FIG. 5B is a block diagram depicting a continuous collision detection method 602, according to at least one embodiment. The collision detection method 602 may be performed by the optimization functionality described previously. Block 604a depicts a sweep backward and block 604b depicts a sweep forward.

At block 604c, the optimization logic may discretize a trajectory of a sphere 606 (e.g., one of the set of spheres representing a manipulator) at, for example, three timesteps represented by S₀, S₁, and S₂. The timestep S₀ as depicted represents a starting point, the timestep S₂ represents an ending point, and the timestep S₁ represents a time point along a motion path 608 of motion between the timesteps S₀ and S₂. At S₁ the sphere 606 is a signed distance 610 away from an obstacle 612. The optimization logic tests whether the sphere 606 is in collision with the obstacle 612 at S₁. If so, the optimization logic determines a collision cost and may add this cost to a world collision cost. The sweeps backward and forward may be skipped under these circumstances.

If the sphere 606 is not in collision at S₁, the optimization logic may sweep backward, as per block 604a and determine a signed distance to a nearest obstacle (in this example obstacle 612). If this distance is greater than a distance between the timestep S₁ and a backward midpoint 614 between the timesteps S₀ and S₁, there are no obstacles along the motion path 608 with which the sphere 606 will collide along this direction. The sweep backward may be skipped in this circumstance.

If the signed distance is less than or equal to the distance between the timestep S₁ and the backward midpoint 614, the optimization logic may move the sphere 606 this distance in a direction opposite the direction of the motion path 608 (between the at the timesteps S₀ and S₁) to a new position 616. If, at the new position 616, the sphere 606 would be in a collision, the optimization logic may compute a collision cost (e.g., and add it to the world collision cost). The sweep backward may continue until the sphere 606 is in collision, or if the sphere 606 reaches or passes the backward midpoint 614 between the timesteps S₀ and S₁. The sweep backward may also be terminated before reaching the backward midpoint 614 if all external objects have tested negative for collision with the sphere 606, or if a distance to the closest external obstacle is greater than the distance between the sphere 606 and the backward midpoint 614.

A sweep forward, as depicted for example in block 604b, may be performed by the optimization logic before or after a sweep backward. The sweep forward is carried out in a manner similar to the sweep backward in some aspects, but in a forward direction in regards to a forward midpoint 618 of the distance between S₁ and S₂ along the motion path 608.

Backward and forward sweeping may be repeated for each timestep along the motion path 608.

By way of a non-limiting example, Algorithm 3 below may be utilized to determine a world-collision distance, although any suitable variations thereof may be utilized.

Algorithm 3: World Collision Distance

Kernel Launch Data: Launch 1 thread per sphere
World Model Input: obb_bounds, obb_pose, obb_enable, max
nobs, nboxes
Collision Config Input: activation_distance, weight
Input: b_robot_spheres, env_idx, B, H, M
Output: out_distance, out_grad
Data: sparsity_idx

| /* Compute ids from thread indices | | */ |
|---|---|---|
| 1 | bid = tid / (H, M) | |
| 2 | hid = (tid − bid * H * M) / M | |
| 3 | sid = (tid − bid * H * M − hid * M) | |
| 4 | sph_idx = bid * H * M + hid * M + sid | |
| 5 | sph = b_robot_spheres[sph_idx] | [symbol] Read sphere from |

global memory

| | |
|---|---|
| 6 | if sph.radius < 0.0 then |
| 7 | return |
| 8 | max_dist = 0 |
| 9 | sum_grad = 0 |
| 10 | eta = activation_distance |
| 11 | start_box_idx = env_idx * max_nobs |
| 12 | for (box_idx = 0; box_idx< nboxes; box_idx++) do |
| 13 | if obb_enable[start_box_idx + box_idx] == 0 then |
| 14 | continue |
| 15 | loc_sph = transform_sphere(obb_pose[start_box_idx + |

box_idx], sph)

| | |
|---|---|
| 16 | loc_bounds = obb_bounds[start_box_idx + box_idx] |
| 17 | loc_bounds = loc_bounds / 2 |
| 18 | if check_sphere_aabb(loc_bounds, loc_sphere) then |
| 19 | loc_bounds += loc_sphere.radius + eta |
| 20 | cl = compute_sphere_gradient(loc_bounds, loc_sphere, |

eta)

| | |
|---|---|
| 21 | max_dist += cl.distance |
| 22 | sum_grad += project_gradient_global_frame(obb_mat[ ], |

cl)

| | |
|---|---|
| 23 | end |
| 24 | end |
| 25 | if max_dist == 0 then |
| 26 | if sparsity_idx[sph_idx] == 0 then |
| 27 | return |
| 28 | sparsity_idx[sph_idx] = 0 |
| 29 | out_grad[sph_idx * 4] = 0 |
| 30 | out_distance[sph_idx] = 0 |
| 31 | end |
| 32 | max_dist = weight * max_dist |
| 33 | sum_grad = weight * sum_grad |
| 34 | out_distance[sph_idx] = max_dist |
| 35 | out_grad[sph_idx * 4] = sum_grad |
| 36 | sparsity_idx[sph_idx] = 1 |

By way of a non-limiting example, Algorithm 4 below may be utilized to determine a world continuous collision distance, although any suitable variations thereof may be utilized.

Algorithm 4: World Continuous Collision Distance

Kernel Launch Data: Launch 1 thread per sphere
World Model Input: obb_bounds, obb_ pose, obb_ enable, max
nobs, nboxes
Collision Config Input: activation_distance, weight, steps,
speed_dt
Input: b_robot_spheres, env_idx, B, H, M
Output: out_distance, out_grad
Data: sparsity_idx
/* Compute ids from thread indices */

| | |
|---|---|
| 1 | bid = tid / (H, M) |
| 2 | hid = (tid − bid * H * M) / M |
| 3 | sid = (tid − bid * H * M − hid * M) |
| 4 | max_dist = 0 |
| 5 | sum_grad = 0 |
| 6 | sweep_fwd = False |
| 7 | sweep_bwd = False |
| 8 | eta = activation_distance |
| 9 | dt = speed_dt |
| 10 | start_box_idx = env_idx * max_nobs |

/* Read spheres from global memory */

| | |
|---|---|
| 11 | sph1 = b_robot_spheres[(b_addrs + (hid * M ) + sid) * 4] |
| 12 | if sph1.radius < 0.0 then |
| 13 | return |
| 14 | if hid > 0 then |
| 15 | sph0 = b_robot_spheres[(b_addrs + ((hid−1) * M ) + sid) |

* 4]

| | |
|---|---|
| 16 | sph0_distance = sphere_distance(sph0, sph1) |
| 17 | sph0_len = sph0_distance + sph0.radius * 2 |
| 18 | if sph0_distance > 0.0 then |
| 19 | sweep_bwd = True |
| 20 | end |
| 21 | if hid < horizon −1 then |
| 22 | sph2 = b_robot_spheres[(b addrs + ((hid+1) * M ) + sid) |

* 4]

| | |
|---|---|
| 23 | sph2_distance = sphere_distance(sph2, sph1) |
| 24 | sph2_len = sph2_distance + sph2.radius * 2 |
| 25 | if sph2_distance > 0.0 then |
| 26 | sweep_fwd = True |
| 27 | end |

/* Perform continuous collision computation */

| | |
|---|---|
| 28 | max_dist, sum_grad = |

compute_continuous_collision_distance( )

| | |
|---|---|
| 29 | if max_dist == 0 then |
| 30 | if sparsity_idx[sph_idx] == 0 then |
| 31 | return |
| 32 | sparsity_idx[sph_idx] = 0 |
| 33 | out_grad[sph_idx * 4] = 0 |
| 34 | out_distance[sph_idx] = 0 |
| 35 | end |
| 36 | max_dist = weight * max_dist |
| 37 | sum_grad = weight * sum_grad |
| 38 | out_distance[sph_idx] = max_dist |
| 39 | out_grad[sph_idx * 4] = sum_grad |
| 40 | sparsity_idx[sph_idx] = 1 |
| 41 | end |

The sweeps backward and forward may be carried out by representing world (environment) objects as oriented 3D bounding boxes (“OBBs”). The optimization logic may distribute the execution of the algorithms per batch across a number of threads equal to the number of spheres and time horizons. Each thread may load a sphere (e.g., the sphere 606 at timesteps S₁) along with two others (e.g., the spheres at timesteps S₀ and S₂) from adjacent time horizons. For each of the OBBs, the distance between the sphere and OBB may be computed by first rotating (transforming) the sphere to OBBs coordinates. If there is a potential collision, a gradient is computed. If not, the optimization logic may check whether a potential collision is possible between the two adjacent time horizons and compute gradients when a potential collision is detected.

By way of a non-limiting example, Algorithm 5 below may be utilized to perform the sweeps backward and forward, although any suitable variations thereof may be utilized.

Algorithm 5: Sweep with jumps for Continuous Collision Detection

| | |
|---|---|
| 1 | for (box_idx = 0; box_dx< nboxes; box_idx++) do |
| 2 | if obb_enable[start_box_idx + box_idx] == 0 then |
| 3 | continue ; |
| 4 | in_obb_pose = obb_pose[start_box_idx + box_idx]; |
| 5 | loc_sph = transform_sphere(in obb_pose, sph); |
| 6 | loc_bounds = obb_bounds[start_box_idx + box_idx]; |
| 7 | loc_bounds = loc_bounds / 2; |
| 8 | if check_sphere_aabb(loc_bounds, loc_sphere) then |
| 9 | loc_bounds += loc_sphere.radius + eta; |
| 10 | cl = compute_sphere_gradient(loc_bounds, loc_sphere, |

eta);

| | |
|---|---|
| 11 | max_dist += cl.distance; |
| 12 | sum_grad += project_gradient_global_frame(obb_mat[ ], |

cl);

| | |
|---|---|
| 13 | else |
| 14 | jump_distance = compute_distance( ); |
| 15 | end |
| 16 | jump_d = jump_distance; |
| 17 | if sweep_bwd_jump_d < sph0_distance then |
| 18 | loc_sph0 = transform_sphere(in_obb_pose, sph0); |
| 19 | for (j = 0; j< steps; j++) do |
| 20 | if jump_d ≥ sph0_distance then |
| 21 | break; |
| 22 | k0 = 1 − jump_d / (sph0_len); |
| 23 | compute jump distance(loc_sph, loc_sph0, k0, eta, |

loc_bounds, grad_loc_bounds, sum_pt, jump_d);

| | |
|---|---|
| 24 | end |
| 25 | end |
| 26 | if sweep_fwd_jump_d < sph2_distance then |
| 27 | loc_sph2 = transform_sphere(in_obb_pose, sph2); |
| 28 | for (j = 0; j< steps; j++) do |
| 29 | if jump_d ≥ sph2_distance then |
| 30 | break; |
| 31 | k0 = 1 − jump_d / (sph2_len); |
| 32 | compute_jump_distance(loc_sph, loc_sph2, k0, eta, |

loc_bounds, grad_loc_bounds, sum_pt, jump_d);

| | |
|---|---|
| 33 | end |
| 34 | end |
| 35 | if sum_pt.w > 0 then |
| 36 | max_dist += sum_pt.w; |
| 37 | project_gradient_global_frame(in_obb_mat, sum_pt, |

max_grad);

| | |
|---|---|
| 38 | end |
| 39 | end |

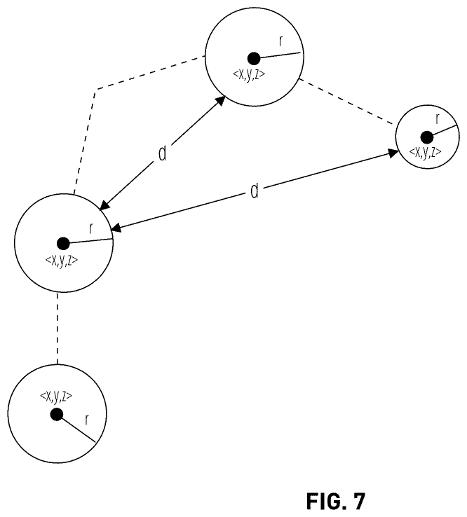

FIG. 7 depicts an example of select spheres from a spherical representation of a robotic manipulator. Self-collision checking of the manipulator may be performed in three phases. First, the spheres of the spherical approximation model may be loaded into machine memory for processing by the self-collision algorithm. The spheres may be parameterized in the memory each by four floating point values: three values <x,y,z> defining a center point and one value r defining a radius. Next, distances (d) may be determined between the surfaces of all pairs of the spheres (in an optimization, spheres on a same linkage of the manipulator may be excluded from being paired, because they cannot physically collide with one another in any scenario). In the third phase a determination is made of which if any distances are associated with collision conditions along various candidate motion paths, and if so, computation of gradients (degree of penetration and motion corrections) to avoid the collisions.

A conventional approach to computing collisions is to repeatedly load a first object (e.g., a sphere, a bounding box) into machine memory, load a second object, compute the distance between their surfaces, and store the result. This approach is computationally inefficient. To improve computational efficiency on processors configured to support matrix manipulation instructions (e.g., certain GPUs), a matrix of many objects may be configured and loaded as a batch, and the distances computed and stored as a batch, using said matrix instructions. In some cases, using said instructions, the results of the matrix computations may be reduced (e.g., to a minimum or maximum result) before being stored.

Conventional matrix multiplication and/or reduction instructions may not operate efficiently on batches of the distance computations utilized in some collision detection applications, such as those used for path planning. For example, the batch execution of distance calculations using matrix math computation (e.g., dot products) may involve the formation of small, dimensionally-asymmetrical matrices. Using conventional matrix instructions, these inputs may not compute/reduce efficiently as do larger, more symmetrical matrices, for example due to cache misses and cache thrashing.

Conventional mechanisms for collision detection and distance calculation may also utilize 32 bit or even 64 bit floating point math operations, which are overly-precise and computationally expensive for many applications.

In one aspect, distance calculations for collision detection or other purposes may be implemented by a processor configured to execute an instruction that will be referred to herein as DISTANCE.

In response to receiving a DISTANCE instruction, a processor configured to implement this instruction (or a similar one) computes a distance between two sphere surfaces, or computes an L2 norm (a basic point-to-point distance) depending on the argument settings for the instruction. In one embodiment a format of the DISTANCE instruction, including arguments, is:
DISTANCE.F32 Rd, Ra, Rb
where Rd, Ra, and Rb refer to either physical or virtual registers, and .F32 specifies the data format for the computed result in register Rd (32-bit floating point in this example). For example:
DISTANCE.F32 R3, R1, R2

In one embodiment each of the arguments in registers Ra and Rb represents a sphere in the form <x,y,z,r>, where x,y,z is the center point of the sphere and r is the radius. Each of <x,y,z,r> is represented by a floating point value in quantized FP8 format, so that the four parameters of the sphere may be packed into a single 32-bit register. The loss of precision resulting from the quantization of the parameters to FP8 may be acceptable for many collision-detection and distance calculation applications, particularly when an E4M3 quantization format is utilized.

The result of a distance calculation may be positive if the two spheres specified in the operands do not collide. The result may be negative if the spheres collide. The DISTANCE instruction in one embodiment may be modified to return zero in place of a computed negative result value by provisioning the instruction with an extension such that the output register holds a zero in case the computed distance is negative. This embodiment of the instruction is referred to herein as DISTANCE.RELU. In response to receiving this form of the DISTANCE instruction, the processor computes:

$${R}_{d} ← RELU ( \sqrt{{( x 2 − x 1 )}^{2} + {( y 2 − y 1 )}^{2} + {( z 2 − z 1 )}^{2}} − r 1 − r 2 )$$

Negative results of the distance computation are set to zero (RELU), a common operation in machine learning applications. If the r values of the two spheres are set to 0, the calculation reduces to an L2 distance (L2 norm) calculation.

In some embodiments, the additions, subtractions, and multiplications of the distance calculation may be implemented within the processor using conventional FP32 or FP64 (or even FP16) arithmetic logic units (ALU) by unpacking the FP8 arguments and converting them into the native computation format of the ALU. In other embodiments, the processor may be configured with an ALU that handles FP8 arguments natively, for example in packed batches. In one embodiment, an E4M3 format may be utilized for the FP8-quantized sphere parameters. The E4M3 format (four exponent bits, three mantissa bits, one sign bit) may demonstrate superior L2 precision loss over the ranges of distances encountered in some collision detection applications, such as robotic manipulator path planning.

In the embodiment described above, the DISTANCE instruction comprises an optional specifier (F32) defining a format for the result returned in Rd. In this example, the optional specifier indicates that the result should be formatted as FP32 (this or another format may also be the default when no specifier is indicated). Other specifiers may indicate that the returned result be formatted as FP8, FP16, or some other quantized format, especially for embodiments in which the DISTANCE instruction is compounded to perform multiple distance computations, as described below.

In some implementations the processor may be configured to implement the distance calculation between multiple spheres, or multiple L2 norms, in response to a single instruction as follows:
DISTANCE2.F16 Rd, Ra, Rb, Rc

Each of Ra, Rb, and Rc comprises an FP8-formatted parametric sphere of the form <x,y,z,r>. This instruction, when applied to a processor configured to implement it, may return the surface-to-surface distance between the pair of spheres Ra and Rb and also the surface-to-surface distance between the pair of spheres Ra and Rc. The two FP16-formatted returned distance values are packed into 32-bit register Rd. The instruction may be further extended, for example to calculate the surface-to-surface distance between all three sphere pairs (Ra-Rb, Ra-Rc, Rb-Rc), with the three results formatted as FP8 and packed into (e.g., low order bits of) Rd. For example:
DISTANCE3.F8 R4, R1, R2, R3

In one implementation, the distance instruction may be invoked to determine collisions between spheres in n×n batches. Each batch represents a total of n² sphere pairings. Batches may be executed in parallel by a set of T threads executing in a SIMT (Single Instruction Multiple Thread) mode, wherein each batch is processed by T/P threads, where P is a number of execution partitions in the SIMT processor. In one embodiment, T=32, P=4, and the set of T threads may be referred to as a warp. The warp may execute on a streaming multiprocessor of a GPU.

Internally, the processor may be organized into P>1 execution partitions, and a group of P threads may be assigned to each partition for execution. A number P of n×n distance computations may therefore be executed per warp in one embodiment.

To further improve execution efficiency, the threads in a partition may share registers using a novel mechanism described in more detail below.

To enhance parallelism in the computation of distances, intra-partition register sharing among threads may be implemented via an enhanced register-to-register MOV (“move”) instruction, herein referred to as QMOV.

### QMOV Rd, Ra, Rb

An appropriately configured processor may parse this instruction into a thread index, a register specifier, and a destination operand, and respond by moving a value from source register Ra in a thread with index (or, more generally, id) Rb to (thread local) destination register Rd. In one embodiment the thread identifier/index is a unique identifier (e.g., an index/ordinal) within a set of identifiers equal in size to a number of threads assigned to an execution partition of the processor. To implement this instruction, the processor (e.g., a streaming multiprocessor) may utilize register collectors in some or each of its partitions.

Within a partition, the register collector stores local values for certain registers referenced by the threads executing in the partition. For example, a register collector may store one current value to associate with local register R1 for thread1 of the partition, a different value to associate with local register R1 for thread2 of the partition, and so on. In this example, when a thread of the partition references register R1, a conventional register MOV instruction will return the corresponding value of R1 stored in the collector to the thread referencing the register, so that each thread receives its (possibly different) thread-local value of R1 in response to referencing register R1 in a MOV instruction.

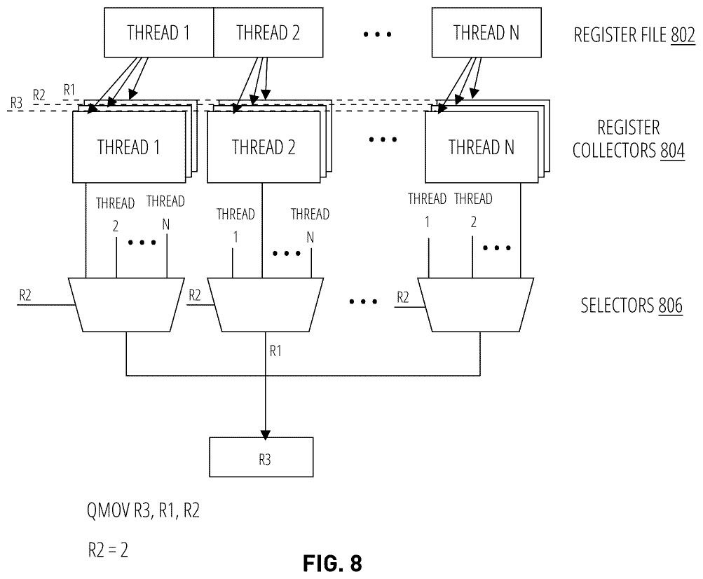

The QMOV instruction enables a thread to cause the processor to return a value of a register associated with a different thread of the partition. For example, QMOV R3, R1, 2 called from thread1 of a given partition will return in R3 the value of R1 associated with thread2 of that partition. FIG. 8 depicts exemplary processor logic comprising a register file 802, register collectors 804, and selectors 806 to implement an instruction in accordance with the QMOV embodiment described herein.

Faster and more efficient collision detection for robotic motion path configuration and other applications may be enabled utilizing embodiments of the DISTANCE.RELU instruction in conjunction with embodiments of the QMOV instruction and embodiments of a third instruction, herein referred to WARGMNMX. In one embodiment the format of this instruction is:
x_ARGMNMX.OP.TYPE Rd, Ra

This instruction performs a reduction of a set (e.g., a one-dimensional vector) of local register values used by a set of threads, where x_indicates the scope of the thread group. The instruction returns in Rd the index of the thread in a group of threads associated with either the maximum or the minimum value of Ra. The .OP specifier indicates the operation−maximum (MAX) or minimum (MIN). The .TYPE specifier indicates the format of the operand in Ra, and may for example be set to .F32, .F16, or .F8. Depending on the implementation, the group of threads may be for example an entire warp, or the group of threads assigned to execute in a partition of the processor. For example:
WARGMNMX.MAX.F32 R2, R1
returns in R2 the index of the thread in an invoking warp with the highest value in local register R1 from among all the threads in the warp. In this example, W indicates the scope of the group is an entire warp, and the optional specifier F32 indicates the data format of operand R1 to be FP32. On computing platforms where a warp comprises 32 threads, the result returned in R2 may range between 0 and 32.

Another example embodiment of this instruction with a thread partition (e.g., quad) scope comprising a subset of threads in a warp is:
QARGMNMX.MAX.F32 R2, R1

Among other applications, this instruction may be utilized to improve the calculation speed and efficiency of gradients in collision detection and path planning, and may be extended in some implementations to return the thread index associated with the maximum or minimum value of multiple local registers. For example
x_ARGMNMX.MAX.F32 R3, R1, R2

This instruction, when applied to a processor configured to implement it, returns the thread indices associated with the maximum values in registers R1 and R2 for threads in the specified scope (x_). In one implementation, the returned results may be packed into R3 with low order 16 bits specifying the thread with the maximum value and the high order 16 bits specifying which register (e.g., R1 or R2) in that thread has the maximum value. In another implementation, the returned results may be packed into R3 with low order 16 bits specifying the thread with the maximum local value of the first register (e.g., R1) and the high order 16 bits specifying the thread with the maximum local value of the second register (e.g., R2).

An embodiment of this instruction may also be implemented to operate on packed thread-local values. For example:
ARGMNMX.MAX.F8 R3, R1, R2

This instruction, when applied to a processor configured to implement it, returns the thread indices associated with the maximum of the eight FP8 quantized values packed into registers R1 and R2. The returned result will range from 0 to 8.

Some embodiments of the instructions described above are summarized in the table below.

| Type | Instruction | Description |
|---|---|---|
| Intra-quad | QMOV Rd, Ra, Rb | Read register Ra from thread Rb |
| register | | |
| read | | |
| Intra- | x_ARGMNMX.F32 Rd, Ra | x_-scope arg-min/max using |
| group | | FP32 Ra. |
| min/max | ARGMNMX.OP.F8 Rd, Ra, Rb | reduce 8 values in Ra, Rb to max |
| | | or min |
| Distance | DISTANCE.RELU.F32 Rd, Ra, Rb | Compute L2 distance between to |
| calculation | | spheres |
| | DISTANCE.RELU.F16 Rd, Ra, Rb, Rc | Compute two L2 distances |
| | | between Ra, Rb and Ra, Rc. |

Algorithm 6 below depicts an exemplary algorithm for collision checking between spheres in accordance with the mechanisms described above. Details such as initialization of some variables, and setting of certain parameters, are omitted to remain concise but will be evident to those of ordinary skill in the art.

Algorithm 6: Sweep with jumps for Continuous Collision Detection

```
for (int k=1; k<8; k++) {
  //execute QMOV to get register value
  //from ((threadid/8)*8+k)^{th} thread
  sph2′ = quad_getreg_asm(sph2, k); //QMOV sph2′, sph2, k
  //execute DISTANCE.RELU.F32 to compute
  //the distance between two spheres
  d = distance_threshold_asm(sph1, sph2′);
  if (d > max_d.d) {
    max_d.d = d;
    mad_d.j = k;
  }
}
max_d.j +=j;
//execute WARGMNMX.F32 to get the index of the thread
//that computed the maximum distance
// set bitmask to indicate the active threads in the warp
mask = _{——}ballot_sync(0xffffffff, threadIdx.x < blockDim.x);
max_tid = argmax_warp_asm(mask, max_d.d);
// thread index max_tid has the maximum value in the warp
// Only the thread with index max_tid will do the following
// work, i.e., store the data associated in that thread
if (threadIdx.x % 32 == max_tid) {
  warp_idx = threadIdx.x/32;
  max_darr[warp_idx] = &max_d;
}
```

The following table describes embodiments of additional instructions for executing quantized floating point computations. Utilization of these instructions may improve the computational speed and/or reduce the power consumption of collision detection, motion planning, and other applications.

| Type | Instruction | Description |
|---|---|---|
| Min/Max | MNMX.FP8 Rd, Ra, Rb | args are local; Ra, Rb contain four FP8 values |
| reduction | | each. |
| Quantized | FADD.F8 Rd, Ra, Rb | Elementwise (signed) add of Ra with Rb, each |
| Math | | holding four FP8 values |
| Quantized | FADD3.FP8 Rd, Ra, | Elementwise (signed) add of Ra with Rb with Rc, |
| Math | Rb, Rc | each holding four FP8 values |
| Quantized | FSCALE.F8.F32 Rd, | Scale four fp8 values in Ra each with FP32 Rb |
| Math | Ra, Rb | Result can be formatted FP8, FP16, or FP32 |

The following table describes embodiments of additional instructions for executing floating point math computations on parameterized points. Utilization of these instructions may improve the computational speed and/or reduce the power consumption of collision detection, motion planning, and other applications.

| Type | Instruction | Description |
|---|---|---|
| Point | PKPT.FP16.RbHi Rd, | Pack into Rd an FP16 point <x, y, z> |
| Packing/Unpacking | Ra, Rb | from Ra and high-order bits of Rb |
| | | (specified by the RbHi modifier) |
| | UNPKPT.FP16 Rd, Ra | Unpack an FP16 point stored in Ra. |
| Point Math | PSUB Rd, Ra, Rb | Subtract two points (Ra − Rb) |
| | PADD Rd, Ra, Rb | Add two points (Ra + Rb) |
| | PMUL Rd, Ra, Rb | Multiply a point Ra by a scalar Rb. |
| | PDIV Rd, Ra, Rb | Divide a point with a scalar Rb. |
| Min/Max | PTMNMX.OP.C | Return the component-wise min/max of |
| | Rd, Ra, Rb | the point coordinates. |
| | | Rd.x = max/min(Ra.x, Rb.x) |
| | | Rd.y = max/min(Ra.y, Rb.y) |
| | | Rd.z = max/min(Ra.z, Rb.z) |
| | PTMNMX.OP.V | Vector min/max |
| | Rd, Ra, Rb | Vector min/max from six values |
| | | Rd is set to the min/max value |
| | | Rd + 1 is set to an indication of whether |
| | | Rd is x, y, or z coordinate (int 0-2) |
| | | Rd = min/max(Ra.x, Ra.y, Ra.z, Rb.x, |
| | | Rb.y, Rb.z) |
| Distance | PDISTANCE Rd, Ra, Rb | Compute the distance between two |
| Computation | | points Ra and Rb, result in Rd |
| Point Rotation | PTRT Rd, Ra, Rb, Rc | Rotate point coordinates around a given |
| | | axis. Ra is the input point. Rb and Rc |
| | | store four FP16 values for the |
| | | quaternion <qw, qx, qy, qz>. |

In some embodiments, the points may be quantized into an E5M4 format. This format is useful for packing points comprising 30 bits of <x,y,z> coordinates into a 32 bit register, and may benefit from being computationally compatible with conventional 16-bit ALU logic configured to operated on E5M10 data formats. An E5M4 value may be configured into an E5M10-compliant register by packing 0s into the lower six bits.

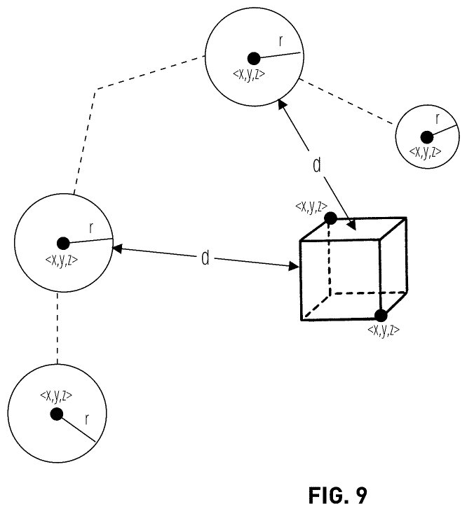

FIG. 9 depicts an example of select spheres from a spherical representation of a robotic manipulator in relation to a bounding box of an object in the robotic manipulator's environment. Collision detection between a sphere of spherical model and the bounding box of the object may be carried out by determination of a point on the bounding box closest to the surface of the sphere. As noted previously, these calculations may be made more computationally efficient by quantizing the parameterized points and spheres into E5M4 and/or E4M3 floating point values, respectively. To pack points into formats other than E5M4, the PKPT_FP16_RbHi instruction described above may be utilized. The input Ra 32-bit register comprises two FP16 input values (e.g., for the x,y coordinates of the point) and the high-order 16 bits in Rb comprises a third value (e.g., for the z coordinate). Based on the specified format to be used for the point representation, the corresponding floating-point conversion hardware may implement the type conversion in known manners and the result may be packed into the destination register Rd.

Algorithm 7 below is an example of logic to determine the closest point on the surface of a cube (e.g., a 3D bounding box for an object in a robot's environment) to another point in 3-space. The algorithm may also be utilized to find the closest point on the surface of the cube to the surface of a sphere. The cube may be parameterized by a vector of six values: {x_min, y_min, z_min, x_max, y_max, z_max}. These are the minimum and maximum coordinates of the cube in 3-space.

Algorithm 7: Compute a closest point on a bounding box of an object
to another point in 3-space (e.g., a point on the surface of a sphere

```
//cube: [minx, miny, minz, maxx, maxy, maxz]
//execute two PTMNMX.C Rd, Ra, Rb, Pp instructions to
identify
//closest point
closest_point = max(cube[:2], min(point, cube[3:]));
if equal(closest_point, point) {
  //point is internal of the cube
  closest_point = point;
  //find the closest cube surface plane to the point
  //execute PTMNMX.V Rd, Ra, Rb, Pp to identify
  //minimum index
  // Ra will be the point (point-cube [:2])
  // Rb will be the point (cube[3:]-point)
  // Rd+1 will hold the resulting index mi
  mi = min_idx(point-cube[:2], cube[3:]-point);
  //to derive the closest cube surface to the point under
  //test, replace the corresponding value in the point
  closest_point[mi % 3] = cube[mi];
}
```

To simplify and speed up aspects of Algorithm 7, the point (for which to locate a nearest point on the bounding box) may be rotated to a coordinate frame the axes of which are aligned with the edges of the bounding box. The previously described PTRT instruction may be utilized for this purpose. For computational efficiency the point may be represented in a quantized floating-point format (e.g., E4M5) and packed into a 32-bit register (e.g., Ra). The four parameters of the quaternion defining the rotation may be represented in FP16 format and packed into two 32-bit registers (e.g., Rb and Rc).

Other beneficial applications of the point operation mechanisms described herein include the computerized manipulation of point-cloud representations of 3D objects, and more generally any application utilizing floating-point geometric calculations involving points.

The mechanisms disclosed herein may be implemented in computing devices utilizing one or more graphic processing unit (GPU) and/or general purpose data processor (e.g., a ‘central processing unit or CPU). Exemplary architectures will now be described that may be configured to implement the mechanisms disclosed herein on such devices.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

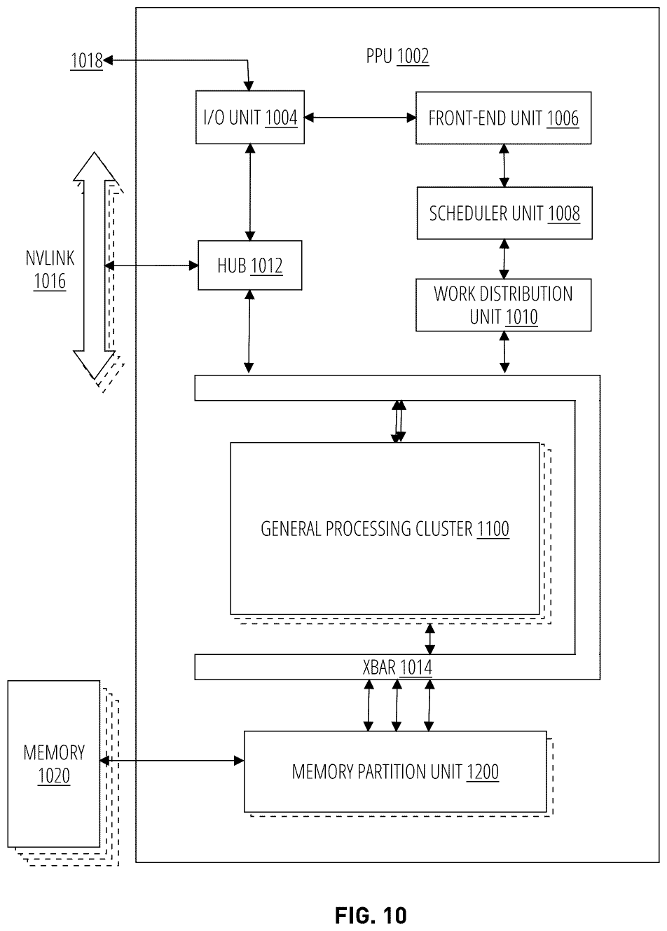

FIG. 10 depicts a parallel processing unit 1002, in accordance with an embodiment. In an embodiment, the parallel processing unit 1002 is a multi-threaded processor that is implemented on one or more integrated circuit devices. The parallel processing unit 1002 is a latency hiding architecture designed to process many threads in parallel. A thread (e.g., a thread of execution) is an instantiation of a set of instructions configured to be executed by the parallel processing unit 1002. In an embodiment, the parallel processing unit 1002 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 1002 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 1002 modules may be configured to accelerate thousands of High Performance Computing (HPC), data center, and machine learning applications. The parallel processing unit 1002 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 10, the parallel processing unit 1002 includes an I/O unit 1004, a front-end unit 1006, a scheduler unit 1008, a work distribution unit 1010, a hub 1012, a crossbar 1014, one or more general processing cluster 1100 modules, and one or more memory partition unit 1200 modules. The parallel processing unit 1002 may be connected to a host processor or other parallel processing unit 1002 modules via one or more high-speed NVLink 1016 interconnects. The parallel processing unit 1002 may be connected to a host processor or other peripheral devices via an interconnect 1018. The parallel processing unit 1002 may also be connected to a local memory comprising a number of memory 1020 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 1020 may comprise logic to configure the parallel processing unit 1002 to carry out aspects of the techniques disclosed herein.

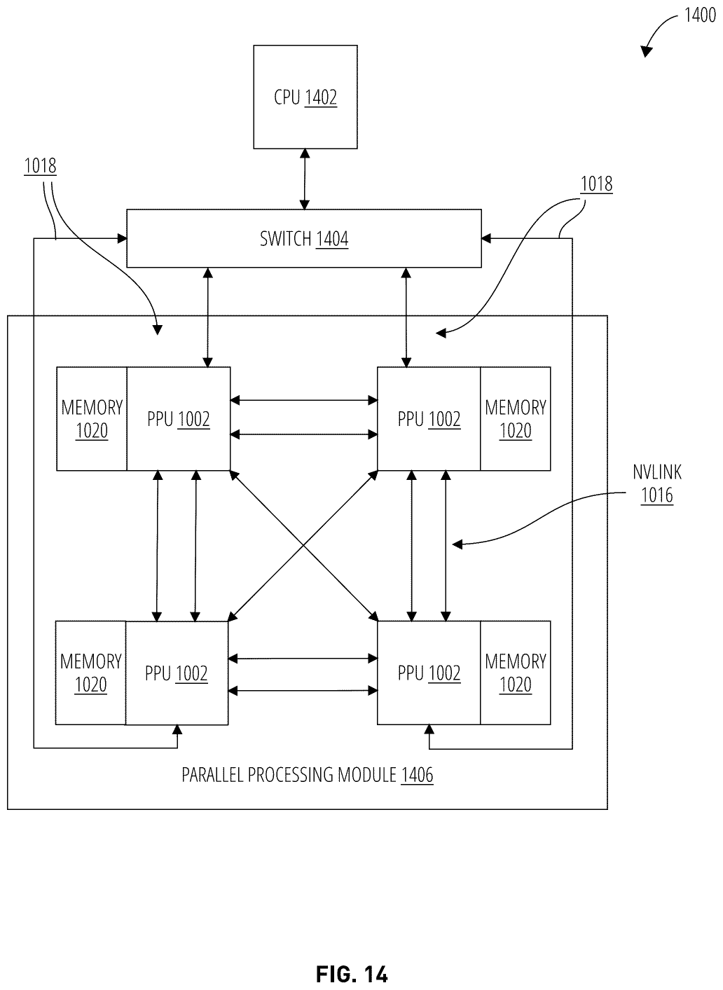

The NVLink 1016 interconnect enables systems to scale and include one or more parallel processing unit 1002 modules combined with one or more CPUs, supports cache coherence between the parallel processing unit 1002 modules and CPUs, and CPU mastering. Data and/or commands may be transmitted by the NVLink 1016 through the hub 1012 to/from other units of the parallel processing unit 1002 such as one or more copy engines, a video encoder, a video decoder, a power management unit, etc. (not explicitly shown). The NVLink 1016 is described in more detail in conjunction with FIG. 14.

The I/O unit 1004 is configured to transmit and receive communications (e.g., commands, data, etc.) from a host processor (not shown) over the interconnect 1018. The I/O unit 1004 may communicate with the host processor directly via the interconnect 1018 or through one or more intermediate devices such as a memory bridge. In an embodiment, the I/O unit 1004 may communicate with one or more other processors, such as one or more parallel processing unit 1002 modules via the interconnect 1018. In an embodiment, the I/O unit 1004 implements a Peripheral Component Interconnect Express (PCIe) interface for communications over a PCIe bus and the interconnect 1018 is a PCIe bus. In alternative embodiments, the I/O unit 1004 may implement other types of well-known interfaces for communicating with external devices.

The I/O unit 1004 decodes packets received via the interconnect 1018. In an embodiment, the packets represent commands configured to cause the parallel processing unit 1002 to perform various operations. The I/O unit 1004 transmits the decoded commands to various other units of the parallel processing unit 1002 as the commands may specify. For example, some commands may be transmitted to the front-end unit 1006. Other commands may be transmitted to the hub 1012 or other units of the parallel processing unit 1002 such as one or more copy engines, a video encoder, a video decoder, a power management unit, etc. (not explicitly shown). In other words, the I/O unit 1004 is configured to route communications between and among the various logical units of the parallel processing unit 1002.

In an embodiment, a program executed by the host processor encodes a command stream in a buffer that provides workloads to the parallel processing unit 1002 for processing. A workload may comprise several instructions and data to be processed by those instructions. The buffer is a region in a memory that is accessible (e.g., read/write) by both the host processor and the parallel processing unit 1002. For example, the I/O unit 1004 may be configured to access the buffer in a system memory connected to the interconnect 1018 via memory requests transmitted over the interconnect 1018. In an embodiment, the host processor writes the command stream to the buffer and then transmits a pointer to the start of the command stream to the parallel processing unit 1002. The front-end unit 1006 receives pointers to one or more command streams. The front-end unit 1006 manages the one or more streams, reading commands from the streams and forwarding commands to the various units of the parallel processing unit 1002.

The front-end unit 1006 is coupled to a scheduler unit 1008 that configures the various general processing cluster 1100 modules to process tasks defined by the one or more streams. The scheduler unit 1008 is configured to track state information related to the various tasks managed by the scheduler unit 1008. The state may indicate which general processing cluster 1100 a task is assigned to, whether the task is active or inactive, a priority level associated with the task, and so forth. The scheduler unit 1008 manages the execution of a plurality of tasks on the one or more general processing cluster 1100 modules.

The scheduler unit 1008 is coupled to a work distribution unit 1010 that is configured to dispatch tasks for execution on the general processing cluster 1100 modules. The work distribution unit 1010 may track a number of scheduled tasks received from the scheduler unit 1008. In an embodiment, the work distribution unit 1010 manages a pending task pool and an active task pool for each of the general processing cluster 1100 modules. The pending task pool may comprise a number of slots (e.g., 32 slots) that contain tasks assigned to be processed by a particular general processing cluster 1100. The active task pool may comprise a number of slots (e.g., 4 slots) for tasks that are actively being processed by the general processing cluster 1100 modules. As a general processing cluster 1100 finishes the execution of a task, that task is evicted from the active task pool for the general processing cluster 1100 and one of the other tasks from the pending task pool is selected and scheduled for execution on the general processing cluster 1100. If an active task has been idle on the general processing cluster 1100, such as while waiting for a data dependency to be resolved, then the active task may be evicted from the general processing cluster 1100 and returned to the pending task pool while another task in the pending task pool is selected and scheduled for execution on the general processing cluster 1100.

The work distribution unit 1010 communicates with the one or more general processing cluster 1100 modules via crossbar 1014. The crossbar 1014 is an interconnect network that couples many of the units of the parallel processing unit 1002 to other units of the parallel processing unit 1002. For example, the crossbar 1014 may be configured to couple the work distribution unit 1010 to a particular general processing cluster 1100. Although not shown explicitly, one or more other units of the parallel processing unit 1002 may also be connected to the crossbar 1014 via the hub 1012.

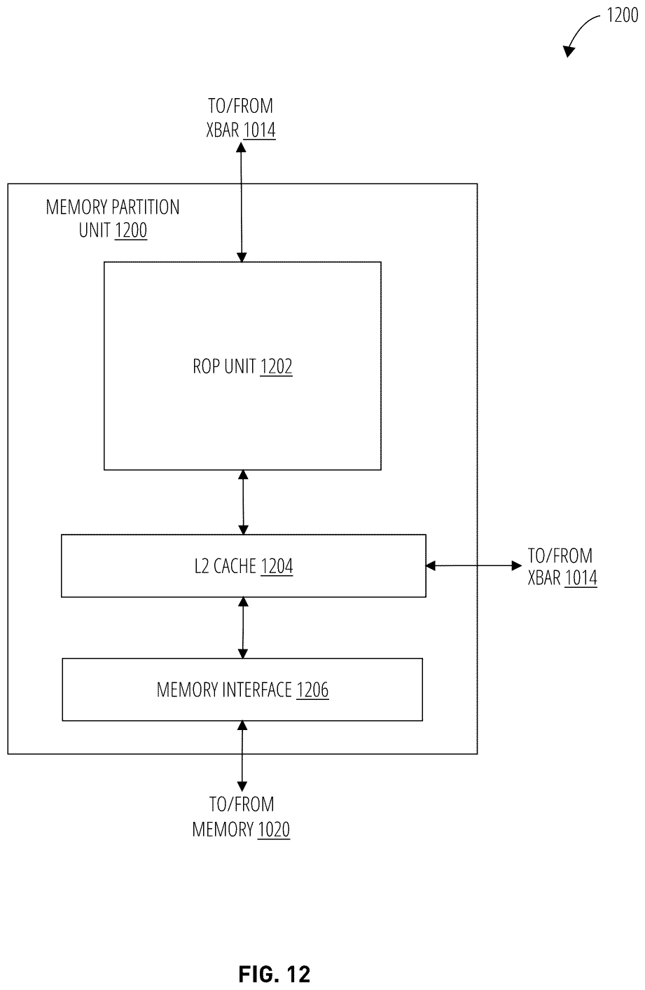

The tasks are managed by the scheduler unit 1008 and dispatched to a general processing cluster 1100 by the work distribution unit 1010. The general processing cluster 1100 is configured to process the task and generate results. The results may be consumed by other tasks within the general processing cluster 1100, routed to a different general processing cluster 1100 via the crossbar 1014, or stored in the memory 1020. The results can be written to the memory 1020 via the memory partition unit 1200 modules, which implement a memory interface for reading and writing data to/from the memory 1020. The results can be transmitted to another parallel processing unit 1002 or CPU via the NVLink 1016. In an embodiment, the parallel processing unit 1002 includes a number U of memory partition unit 1200 modules that is equal to the number of separate and distinct memory 1020 devices coupled to the parallel processing unit 1002. A memory partition unit 1200 will be described in more detail below in conjunction with FIG. 12.

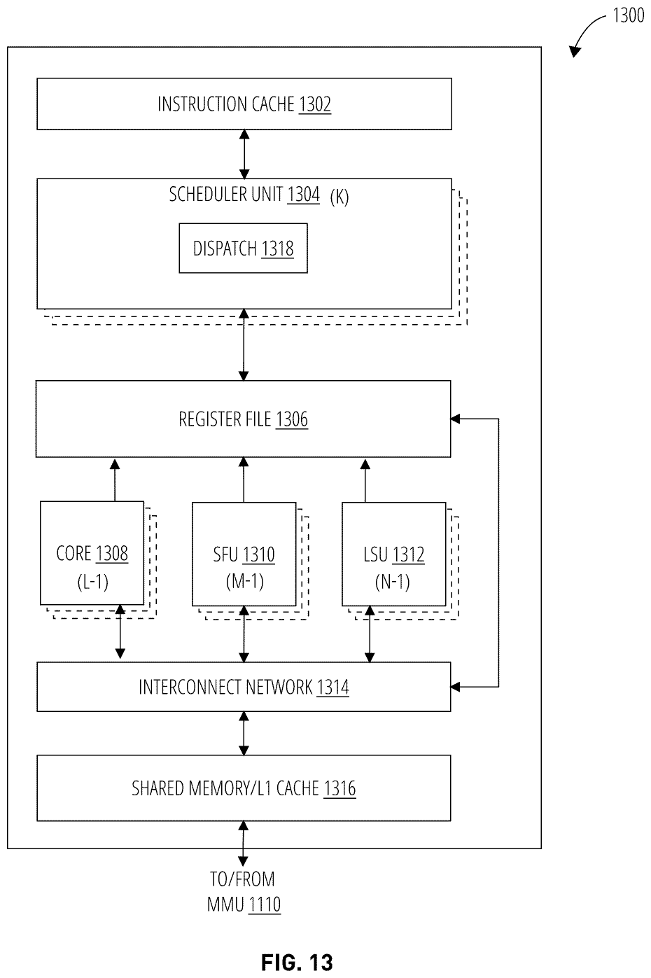

In an embodiment, a host processor executes a driver kernel that implements an application programming interface (API) that enables one or more applications executing on the host processor to schedule operations for execution on the parallel processing unit 1002. In an embodiment, multiple compute applications are simultaneously executed by the parallel processing unit 1002 and the parallel processing unit 1002 provides isolation, quality of service (QoS), and independent address spaces for the multiple compute applications. An application may generate instructions (e.g., API calls) that cause the driver kernel to generate one or more tasks for execution by the parallel processing unit 1002. The driver kernel outputs tasks to one or more streams being processed by the parallel processing unit 1002. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 13.

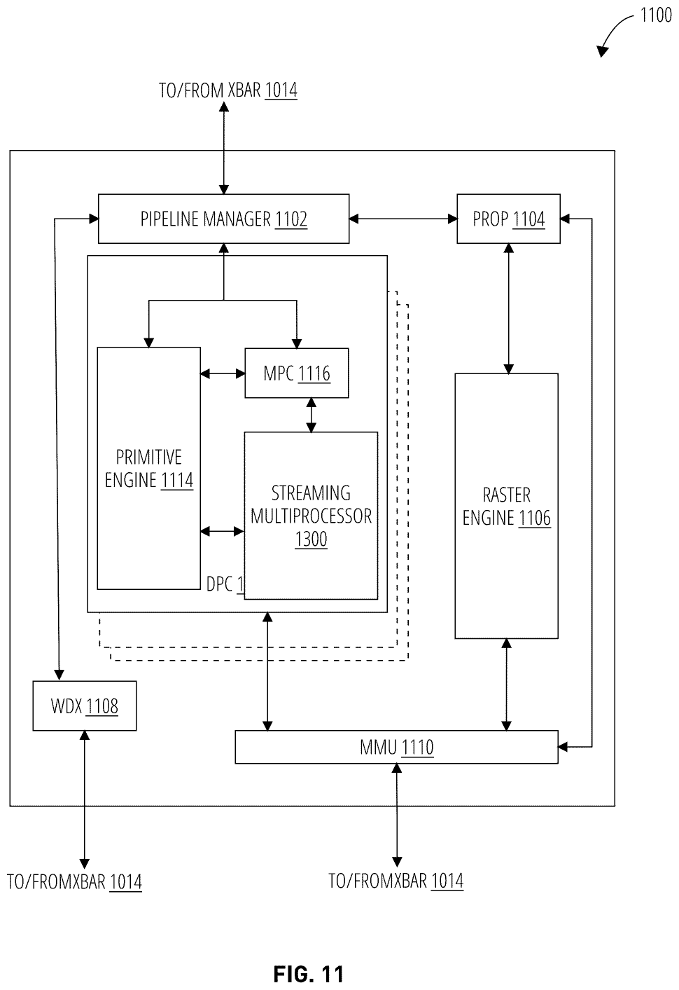

FIG. 11 depicts a general processing cluster 1100 of the parallel processing unit 1002 of FIG. 10, in accordance with an embodiment. As shown in FIG. 11, each general processing cluster 1100 includes a number of hardware units for processing tasks. In an embodiment, each general processing cluster 1100 includes a pipeline manager 1102, a pre-raster operations unit 1104, a raster engine 1106, a work distribution crossbar 1108, a memory management unit 1110, and one or more data processing cluster 1112. It will be appreciated that the general processing cluster 1100 of FIG. 11 may include other hardware units in lieu of or in addition to the units shown in FIG. 11.

In an embodiment, the operation of the general processing cluster 1100 is controlled by the pipeline manager 1102. The pipeline manager 1102 manages the configuration of the one or more data processing cluster 1112 modules for processing tasks allocated to the general processing cluster 1100. In an embodiment, the pipeline manager 1102 may configure at least one of the one or more data processing cluster 1112 modules to implement at least a portion of a graphics rendering pipeline. For example, a data processing cluster 1112 may be configured to execute a vertex shader program on the programmable streaming multiprocessor 1300. The pipeline manager 1102 may also be configured to route packets received from the work distribution unit 1010 to the appropriate logical units within the general processing cluster 1100. For example, some packets may be routed to fixed function hardware units in the pre-raster operations unit 1104 and/or raster engine 1106 while other packets may be routed to the data processing cluster 1112 modules for processing by the primitive engine 1114 or the streaming multiprocessor 1300. In an embodiment, the pipeline manager 1102 may configure at least one of the one or more data processing cluster 1112 modules to implement a neural network model and/or a computing pipeline.

The pre-raster operations unit 1104 is configured to route data generated by the raster engine 1106 and the data processing cluster 1112 modules to a Raster Operations (ROP) unit, described in more detail in conjunction with FIG. 12. The pre-raster operations unit 1104 may also be configured to perform optimizations for color blending, organize pixel data, perform address translations, and the like.

The raster engine 1106 includes a number of fixed function hardware units configured to perform various raster operations. In an embodiment, the raster engine 1106 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1106 comprises fragments to be processed, for example, by a fragment shader implemented within a data processing cluster 1112.

Each data processing cluster 1112 included in the general processing cluster 1100 includes an M-pipe controller 1116, a primitive engine 1114, and one or more streaming multiprocessor 1300 modules. The M-pipe controller 1116 controls the operation of the data processing cluster 1112, routing packets received from the pipeline manager 1102 to the appropriate units in the data processing cluster 1112. For example, packets associated with a vertex may be routed to the primitive engine 1114, which is configured to fetch vertex attributes associated with the vertex from the memory 1020. In contrast, packets associated with a shader program may be transmitted to the streaming multiprocessor 1300.

The streaming multiprocessor 1300 comprises a programmable streaming processor that is configured to process tasks represented by a number of threads. Each streaming multiprocessor 1300 is multi-threaded and configured to execute a plurality of threads (e.g., 32 threads) from a particular group of threads concurrently. In an embodiment, the streaming multiprocessor 1300 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 1300 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 1300 will be described in more detail below in conjunction with FIG. 13.

The memory management unit 1110 provides an interface between the general processing cluster 1100 and the memory partition unit 1200. The memory management unit 1110 may provide translation of virtual addresses into physical addresses, memory protection, and arbitration of memory requests. In an embodiment, the memory management unit 1110 provides one or more translation lookaside buffers (TLBs) for performing translation of virtual addresses into physical addresses in the memory 1020.

FIG. 12 depicts a memory partition unit 1200 of the parallel processing unit 1002 of FIG. 10, in accordance with an embodiment. As shown in FIG. 12, the memory partition unit 1200 includes a raster operations unit 1202, a level two cache 1204, and a memory interface 1206. The memory interface 1206 is coupled to the memory 1020. Memory interface 1206 may implement 32, 64, 128, 1024-bit data buses, or the like, for high-speed data transfer. In an embodiment, the parallel processing unit 1002 incorporates U memory interface 1206 modules, one memory interface 1206 per pair of memory partition unit 1200 modules, where each pair of memory partition unit 1200 modules is connected to a corresponding memory 1020 device. For example, parallel processing unit 1002 may be connected to up to Y memory 1020 devices, such as high bandwidth memory stacks or graphics double-data-rate, version 5, synchronous dynamic random access memory, or other types of persistent storage.

In an embodiment, the memory interface 1206 implements an HBM2 memory interface and Y equals half U. In an embodiment, the HBM2 memory stacks are located on the same physical package as the parallel processing unit 1002, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 1020 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 1002 modules process very large datasets and/or run applications for extended periods.

In an embodiment, the parallel processing unit 1002 implements a multi-level memory hierarchy. In an embodiment, the memory partition unit 1200 supports a unified memory to provide a single unified virtual address space for CPU and parallel processing unit 1002 memory, enabling data sharing between virtual memory systems. In an embodiment the frequency of accesses by a parallel processing unit 1002 to memory located on other processors is traced to ensure that memory pages are moved to the physical memory of the parallel processing unit 1002 that is accessing the pages more frequently. In an embodiment, the NVLink 1016 supports address translation services allowing the parallel processing unit 1002 to directly access a CPU's page tables and providing full access to CPU memory by the parallel processing unit 1002.

In an embodiment, copy engines transfer data between multiple parallel processing unit 1002 modules or between parallel processing unit 1002 modules and CPUs. The copy engines can generate page faults for addresses that are not mapped into the page tables. The memory partition unit 1200 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 1020 or other system memory may be fetched by the memory partition unit 1200 and stored in the level two cache 1204, which is located on-chip and is shared between the various general processing cluster 1100 modules. As shown, each memory partition unit 1200 includes a portion of the level two cache 1204 associated with a corresponding memory 1020 device. Lower level caches may then be implemented in various units within the general processing cluster 1100 modules. For example, each of the streaming multiprocessor 1300 modules may implement an L1 cache. The L1 cache is private memory that is dedicated to a particular streaming multiprocessor 1300. Data from the level two cache 1204 may be fetched and stored in each of the L1 caches for processing in the functional units of the streaming multiprocessor 1300 modules. The level two cache 1204 is coupled to the memory interface 1206 and the crossbar 1014.

The raster operations unit 1202 performs graphics raster operations related to pixel color, such as color compression, pixel blending, and the like. The raster operations unit 1202 also implements depth testing in conjunction with the raster engine 1106, receiving a depth for a sample location associated with a pixel fragment from the culling engine of the raster engine 1106. The depth is tested against a corresponding depth in a depth buffer for a sample location associated with the fragment. If the fragment passes the depth test for the sample location, then the raster operations unit 1202 updates the depth buffer and transmits a result of the depth test to the raster engine 1106. It will be appreciated that the number of partition memory partition unit 1200 modules may be different than the number of general processing cluster 1100 modules and, therefore, each raster operations unit 1202 may be coupled to each of the general processing cluster 1100 modules. The raster operations unit 1202 tracks packets received from the different general processing cluster 1100 modules and determines which general processing cluster 1100 that a result generated by the raster operations unit 1202 is routed to through the crossbar 1014. Although the raster operations unit 1202 is included within the memory partition unit 1200 in FIG. 12, in other embodiment, the raster operations unit 1202 may be outside of the memory partition unit 1200. For example, the raster operations unit 1202 may reside in the general processing cluster 1100 or another unit.

FIG. 13 illustrates the streaming multiprocessor 1300 of FIG. 11, in accordance with an embodiment. As shown in FIG. 13, the streaming multiprocessor 1300 includes an instruction cache 1302, one or more scheduler unit 1304 modules (e.g., such as scheduler unit 1008), a register file 1306, one or more processing core 1308 modules, one or more special function unit 1310 modules, one or more load/store unit 1312 modules, an interconnect network 1314, and a shared memory/L1 cache 1316.

As described above, the work distribution unit 1010 dispatches tasks for execution on the general processing cluster 1100 modules of the parallel processing unit 1002. The tasks are allocated to a particular data processing cluster 1112 within a general processing cluster 1100 and, if the task is associated with a shader program, the task may be allocated to a streaming multiprocessor 1300. The scheduler unit 1008 receives the tasks from the work distribution unit 1010 and manages instruction scheduling for one or more thread blocks assigned to the streaming multiprocessor 1300. The scheduler unit 1304 schedules thread blocks for execution as warps of parallel threads, where each thread block is allocated at least one warp. In an embodiment, each warp executes 32 threads. The scheduler unit 1304 may manage a plurality of different thread blocks, allocating the warps to the different thread blocks and then dispatching instructions from the plurality of different cooperative groups to the various functional units (e.g., core 1308 modules, special function unit 1310 modules, and load/store unit 1312 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1318 unit is configured within the scheduler unit 1304 to transmit instructions to one or more of the functional units. In one embodiment, the scheduler unit 1304 includes two dispatch 1318 units that enable two different instructions from the same warp to be dispatched during each clock cycle. In alternative embodiments, each scheduler unit 1304 may include a single dispatch 1318 unit or additional dispatch 1318 units.

Each streaming multiprocessor 1300 includes a register file 1306 that provides a set of registers for the functional units of the streaming multiprocessor 1300. In an embodiment, the register file 1306 is divided between each of the functional units such that each functional unit is allocated a dedicated portion of the register file 1306. In another embodiment, the register file 1306 is divided between the different warps being executed by the streaming multiprocessor 1300. The register file 1306 provides temporary storage for operands connected to the data paths of the functional units.

Each streaming multiprocessor 1300 comprises L processing core 1308 modules. In an embodiment, the streaming multiprocessor 1300 includes a large number (e.g., 128, etc.) of distinct processing core 1308 modules. Each core 1308 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1308 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1308 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 1300 also comprises M special function unit 1310 modules that perform special functions (e.g., attribute evaluation, reciprocal square root, and the like). In an embodiment, the special function unit 1310 modules may include a tree traversal unit configured to traverse a hierarchical tree data structure. In an embodiment, the special function unit 1310 modules may include texture unit configured to perform texture map filtering operations. In an embodiment, the texture units are configured to load texture maps (e.g., a 2D array of texels) from the memory 1020 and sample the texture maps to produce sampled texture values for use in shader programs executed by the streaming multiprocessor 1300. In an embodiment, the texture maps are stored in the shared memory/L1 cache 1316. The texture units implement texture operations such as filtering operations using mip-maps (e.g., texture maps of varying levels of detail). In an embodiment, each streaming multiprocessor 1300 includes two texture units.

Each streaming multiprocessor 1300 also comprises N load/store unit 1312 modules that implement load and store operations between the shared memory/L1 cache 1316 and the register file 1306. Each streaming multiprocessor 1300 includes an interconnect network 1314 that connects each of the functional units to the register file 1306 and the load/store unit 1312 to the register file 1306 and shared memory/L1 cache 1316. In an embodiment, the interconnect network 1314 is a crossbar that can be configured to connect any of the functional units to any of the registers in the register file 1306 and connect the load/store unit 1312 modules to the register file 1306 and memory locations in shared memory/L1 cache 1316.

The shared memory/L1 cache 1316 is an array of on-chip memory that allows for data storage and communication between the streaming multiprocessor 1300 and the primitive engine 1114 and between threads in the streaming multiprocessor 1300. In an embodiment, the shared memory/L1 cache 1316 comprises 128 KB of storage capacity and is in the path from the streaming multiprocessor 1300 to the memory partition unit 1200. The shared memory/L1 cache 1316 can be used to cache reads and writes. One or more of the shared memory/L1 cache 1316, level two cache 1204, and memory 1020 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1316 enables the shared memory/L1 cache 1316 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 10, are bypassed, creating a much simpler programming model. In the general purpose parallel computation configuration, the work distribution unit 1010 assigns and distributes blocks of threads directly to the data processing cluster 1112 modules. The threads in a block execute the same program, using a unique thread ID in the calculation to ensure each thread generates unique results, using the streaming multiprocessor 1300 to execute the program and perform calculations, shared memory/L1 cache 1316 to communicate between threads, and the load/store unit 1312 to read and write global memory through the shared memory/L1 cache 1316 and the memory partition unit 1200. When configured for general purpose parallel computation, the streaming multiprocessor 1300 can also write commands that the scheduler unit 1008 can use to launch new work on the data processing cluster 1112 modules.

The parallel processing unit 1002 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 1002 is embodied on a single semiconductor substrate. In another embodiment, the parallel processing unit 1002 is included in a system-on-a-chip (SoC) along with one or more other devices such as additional parallel processing unit 1002 modules, the memory 1020, a reduced instruction set computer (RISC) CPU, a memory management unit (MMU), a digital-to-analog converter (DAC), and the like.

In an embodiment, the parallel processing unit 1002 may be included on a graphics card that includes one or more memory devices. The graphics card may be configured to interface with a PCIe slot on a motherboard of a desktop computer. In yet another embodiment, the parallel processing unit 1002 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 14 is a conceptual diagram of a processing system 1400 implemented using the parallel processing unit 1002 of FIG. 10, in accordance with an embodiment. The processing system 1400 includes a central processing unit 1402, switch 1404, and multiple parallel processing unit 1002 modules each and respective memory 1020 modules. The NVLink 1016 provides high-speed communication links between each of the parallel processing unit 1002 modules. Although a particular number of NVLink 1016 and interconnect 1018 connections are illustrated in FIG. 14, the number of connections to each parallel processing unit 1002 and the central processing unit 1402 may vary. The switch 1404 interfaces between the interconnect 1018 and the central processing unit 1402. The parallel processing unit 1002 modules, memory 1020 modules, and NVLink 1016 connections may be situated on a single semiconductor platform to form a parallel processing module 1406. In an embodiment, the switch 1404 supports two or more protocols to interface between various different connections and/or links.

In another embodiment (not shown), the NVLink 1016 provides one or more high-speed communication links between each of the parallel processing unit modules (parallel processing unit 1002, parallel processing unit 1002, parallel processing unit 1002, and parallel processing unit 1002) and the central processing unit 1402 and the switch 1404 interfaces between the interconnect 1018 and each of the parallel processing unit modules. The parallel processing unit modules, memory 1020 modules, and interconnect 1018 may be situated on a single semiconductor platform to form a parallel processing module 1406. In yet another embodiment (not shown), the interconnect 1018 provides one or more communication links between each of the parallel processing unit modules and the central processing unit 1402 and the switch 1404 interfaces between each of the parallel processing unit modules using the NVLink 1016 to provide one or more high-speed communication links between the parallel processing unit modules. In another embodiment (not shown), the NVLink 1016 provides one or more high-speed communication links between the parallel processing unit modules and the central processing unit 1402 through the switch 1404. In yet another embodiment (not shown), the interconnect 1018 provides one or more communication links between each of the parallel processing unit modules directly. One or more of the NVLink 1016 high-speed communication links may be implemented as a physical NVLink interconnect or either an on-chip or on-die interconnect using the same protocol as the NVLink 1016.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1406 may be implemented as a circuit board substrate and each of the parallel processing unit modules and/or memory 1020 modules may be packaged devices. In an embodiment, the central processing unit 1402, switch 1404, and the parallel processing module 1406 are situated on a single semiconductor platform.

In an embodiment, the signaling rate of each NVLink 1016 is 20 to 25 Gigabits/second and each parallel processing unit module includes six NVLink 1016 interfaces (as shown in FIG. 14, five NVLink 1016 interfaces are included for each parallel processing unit module). Each NVLink 1016 provides a data transfer rate of 25 Gigabytes/second in each direction, with six links providing 300 Gigabytes/second. The NVLink 1016 can be used exclusively for PPU-to-PPU communication as shown in FIG. 14, or some combination of PPU-to-PPU and PPU-to-CPU, when the central processing unit 1402 also includes one or more NVLink 1016 interfaces.

In an embodiment, the NVLink 1016 allows direct load/store/atomic access from the central processing unit 1402 to each parallel processing unit module's memory 1020. In an embodiment, the NVLink 1016 supports coherency operations, allowing data read from the memory 1020 modules to be stored in the cache hierarchy of the central processing unit 1402, reducing cache access latency for the central processing unit 1402. In an embodiment, the NVLink 1016 includes support for Address Translation Services (ATS), enabling the parallel processing unit module to directly access page tables within the central processing unit 1402. One or more of the NVLink 1016 may also be configured to operate in a low-power mode.

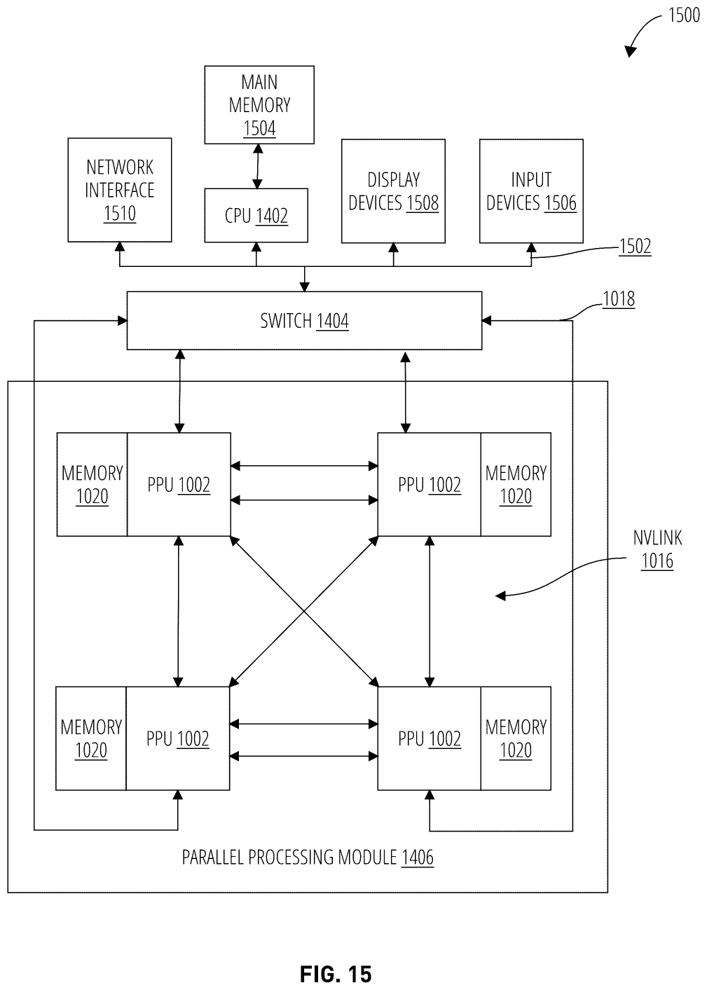

FIG. 15 depicts an exemplary processing system 1500 in which the various architecture and/or functionality of the various previous embodiments may be implemented. As shown, an exemplary processing system 1500 is provided including at least one central processing unit 1402 that is connected to a communications bus 1502. The communication communications bus 1502 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 1500 also includes a main memory 1504. Control logic (software) and data are stored in the main memory 1504 which may take the form of random access memory (RAM).

The exemplary processing system 1500 also includes input devices 1506, the parallel processing module 1406, and display devices 1508, e.g. a conventional CRT (cathode ray tube), LCD (liquid crystal display), LED (light emitting diode), plasma display or the like. User input may be received from the input devices 1506, e.g., keyboard, mouse, touchpad, microphone, and the like. Each of the foregoing modules and/or devices may even be situated on a single semiconductor platform to form the exemplary processing system 1500. Alternately, the various modules may also be situated separately or in various combinations of semiconductor platforms per the desires of the user.

Further, the exemplary processing system 1500 may be coupled to a network (e.g., a telecommunications network, local area network (LAN), wireless network, wide area network (WAN) such as the Internet, peer-to-peer network, cable network, or the like) through a network interface 1510 for communication purposes.

The exemplary processing system 1500 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1504 and/or the secondary storage. Such computer programs, when executed, enable the exemplary processing system 1500 to perform various functions. The main memory 1504, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 1500 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Graphics Processing Pipeline

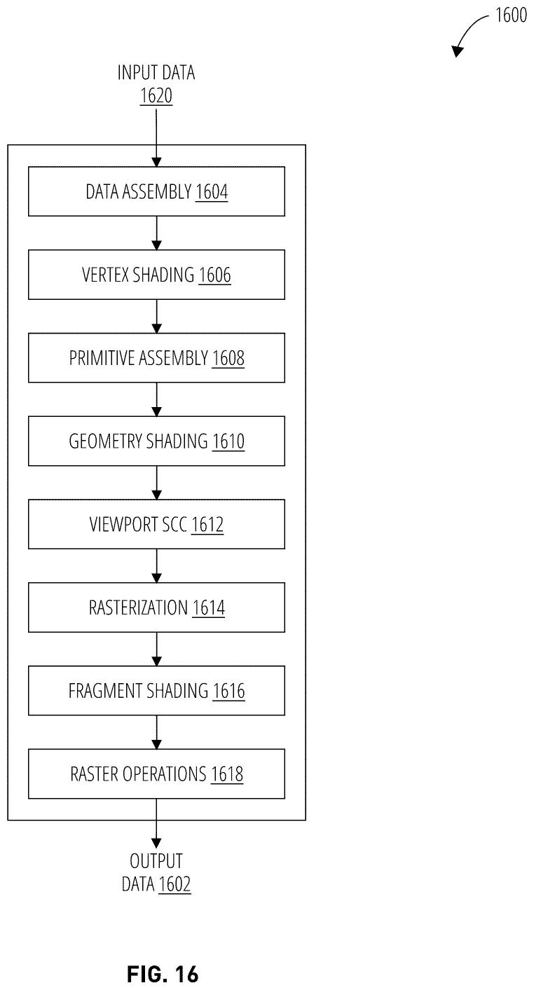

FIG. 16 is a conceptual diagram of a graphics processing pipeline 1600 implemented by the parallel processing unit 1002 of FIG. 10, in accordance with an embodiment. In an embodiment, the parallel processing unit 1002 comprises a graphics processing unit (GPU). The parallel processing unit 1002 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 1002 can be configured to process the graphics primitives to generate a frame buffer (e.g., pixel data for each of the pixels of the display).

An application writes model data for a scene (e.g., a collection of vertices and attributes) to a memory such as a system memory or memory 1020. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 1300 modules of the parallel processing unit 1002 including one or more of a vertex shader, hull shader, domain shader, geometry shader, and a pixel shader. For example, one or more of the streaming multiprocessor 1300 modules may be configured to execute a vertex shader program that processes a number of vertices defined by the model data. In an embodiment, the different streaming multiprocessor 1300 modules may be configured to execute different shader programs concurrently. For example, a first subset of streaming multiprocessor 1300 modules may be configured to execute a vertex shader program while a second subset of streaming multiprocessor 1300 modules may be configured to execute a pixel shader program. The first subset of streaming multiprocessor 1300 modules processes vertex data to produce processed vertex data and writes the processed vertex data to the level two cache 1204 and/or the memory 1020. After the processed vertex data is rasterized (e.g., transformed from three-dimensional data into two-dimensional data in screen space) to produce fragment data, the second subset of streaming multiprocessor 1300 modules executes a pixel shader to produce processed fragment data, which is then blended with other processed fragment data and written to the frame buffer in memory 1020. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline 1600 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 1600 receives input data 601 that is transmitted from one stage to the next stage of the graphics processing pipeline 1600 to generate output data 1602. In an embodiment, the graphics processing pipeline 1600 may represent a graphics processing pipeline defined by the OpenGL® API. As an option, the graphics processing pipeline 1600 may be implemented in the context of the functionality and architecture of the previous Figures and/or any subsequent Figure(s).

As shown in FIG. 16, the graphics processing pipeline 1600 comprises a pipeline architecture that includes a number of stages. The stages include, but are not limited to, a data assembly 1604 stage, a vertex shading 1606 stage, a primitive assembly 1608 stage, a geometry shading 1610 stage, a viewport SCC 1612 stage, a rasterization 1614 stage, a fragment shading 1616 stage, and a raster operations 1618 stage. In an embodiment, the input data 1620 comprises commands that configure the processing units to implement the stages of the graphics processing pipeline 1600 and geometric primitives (e.g., points, lines, triangles, quads, triangle strips or fans, etc.) to be processed by the stages. The output data 1602 may comprise pixel data (e.g., color data) that is copied into a frame buffer or other type of surface data structure in a memory.

The data assembly 1604 stage receives the input data 1620 that specifies vertex data for high-order surfaces, primitives, or the like. The data assembly 1604 stage collects the vertex data in a temporary storage or queue, such as by receiving a command from the host processor that includes a pointer to a buffer in memory and reading the vertex data from the buffer. The vertex data is then transmitted to the vertex shading 1606 stage for processing.

The vertex shading 1606 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 1606 stage may manipulate individual vertex attributes such as position, color, texture coordinates, and the like. In other words, the vertex shading 1606 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 1606 stage generates transformed vertex data that is transmitted to the primitive assembly 1608 stage.

The primitive assembly 1608 stage collects vertices output by the vertex shading 1606 stage and groups the vertices into geometric primitives for processing by the geometry shading 1610 stage. For example, the primitive assembly 1608 stage may be configured to group every three consecutive vertices as a geometric primitive (e.g., a triangle) for transmission to the geometry shading 1610 stage. In some embodiments, specific vertices may be reused for consecutive geometric primitives (e.g., two consecutive triangles in a triangle strip may share two vertices). The primitive assembly 1608 stage transmits geometric primitives (e.g., a collection of associated vertices) to the geometry shading 1610 stage.

The geometry shading 1610 stage processes geometric primitives by performing a set of operations (e.g., a geometry shader or program) on the geometric primitives. Tessellation operations may generate one or more geometric primitives from each geometric primitive. In other words, the geometry shading 1610 stage may subdivide each geometric primitive into a finer mesh of two or more geometric primitives for processing by the rest of the graphics processing pipeline 1600. The geometry shading 1610 stage transmits geometric primitives to the viewport SCC 1612 stage.

In an embodiment, the graphics processing pipeline 1600 may operate within a streaming multiprocessor and the vertex shading 1606 stage, the primitive assembly 1608 stage, the geometry shading 1610 stage, the fragment shading 1616 stage, and/or hardware/software associated therewith, may sequentially perform processing operations. Once the sequential processing operations are complete, in an embodiment, the viewport SCC 1612 stage may utilize the data. In an embodiment, primitive data processed by one or more of the stages in the graphics processing pipeline 1600 may be written to a cache (e.g. L1 cache, a vertex cache, etc.). In this case, in an embodiment, the viewport SCC 1612 stage may access the data in the cache. In an embodiment, the viewport SCC 1612 stage and the rasterization 1614 stage are implemented as fixed function circuitry.

The viewport SCC 1612 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization 1614 stage.

The rasterization 1614 stage converts the 3D geometric primitives into 2D fragments (e.g. capable of being utilized for display, etc.). The rasterization 1614 stage may be configured to utilize the vertices of the geometric primitives to setup a set of plane equations from which various attributes can be interpolated. The rasterization 1614 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 1614 stage generates fragment data (e.g., interpolated vertex attributes associated with a particular sample location for each covered pixel) that are transmitted to the fragment shading 1616 stage.

The fragment shading 1616 stage processes fragment data by performing a set of operations (e.g., a fragment shader or a program) on each of the fragments. The fragment shading 1616 stage may generate pixel data (e.g., color values) for the fragment such as by performing lighting operations or sampling texture maps using interpolated texture coordinates for the fragment. The fragment shading 1616 stage generates pixel data that is transmitted to the raster operations 1618 stage.

The raster operations 1618 stage may perform various operations on the pixel data such as performing alpha tests, stencil tests, and blending the pixel data with other pixel data corresponding to other fragments associated with the pixel. When the raster operations 1618 stage has finished processing the pixel data (e.g., the output data 1602), the pixel data may be written to a render target such as a frame buffer, a color buffer, or the like.

It will be appreciated that one or more additional stages may be included in the graphics processing pipeline 1600 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 1610 stage). Other types of graphics processing pipelines are contemplated as being within the scope of the present disclosure. Furthermore, any of the stages of the graphics processing pipeline 1600 may be implemented by one or more dedicated hardware units within a graphics processor such as parallel processing unit 1002. Other stages of the graphics processing pipeline 1600 may be implemented by programmable hardware units such as the streaming multiprocessor 1300 of the parallel processing unit 1002.

The graphics processing pipeline 1600 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 1002. The API provides an abstraction for a programmer that lets a programmer utilize specialized graphics hardware, such as the parallel processing unit 1002, to generate the graphical data without requiring the programmer to utilize the specific instruction set for the parallel processing unit 1002. The application may include an API call that is routed to the device driver for the parallel processing unit 1002. The device driver interprets the API call and performs various operations to respond to the API call. In some instances, the device driver may perform operations by executing instructions on the CPU. In other instances, the device driver may perform operations, at least in part, by launching operations on the parallel processing unit 1002 utilizing an input/output interface between the CPU and the parallel processing unit 1002. In an embodiment, the device driver is configured to implement the graphics processing pipeline 1600 utilizing the hardware of the parallel processing unit 1002.

Various programs may be executed within the parallel processing unit 1002 in order to implement the various stages of the graphics processing pipeline 1600. For example, the device driver may launch a kernel on the parallel processing unit 1002 to perform the vertex shading 1606 stage on one streaming multiprocessor 1300 (or multiple streaming multiprocessor 1300 modules). The device driver (or the initial kernel executed by the parallel processing unit 1002) may also launch other kernels on the parallel processing unit 1002 to perform other stages of the graphics processing pipeline 1600, such as the geometry shading 1610 stage and the fragment shading 1616 stage. In addition, some of the stages of the graphics processing pipeline 1600 may be implemented on fixed unit hardware such as a rasterizer or a data assembler implemented within the parallel processing unit 1002. It will be appreciated that results from one kernel may be processed by one or more intervening fixed function hardware units before being processed by a subsequent kernel on a streaming multiprocessor 1300.

### LISTING OF DRAWING ELEMENTS

102 instruction
104 processor
106 fetch unit
108 execution unit
202 robotic system
204 communication interface
206 environment
208 object
210 sensor
212 sensor interface
214 processor
216 parallel processing unit
218 memory
220 instructions
222 robot motion control logic
224 user interface
226 sensor data
228 instructions
230 processor
232 memory
234 instructions
236a obstacle
236b obstacle
238 arm
240 communication interface
242 communication interface
244 end effector
246 computing system
248 manipulator
302 robotic manipulator
304 spherical approximation model
402 block
404 block
406 block
408 block
410 block
502 goal pose
504 collision-free trajectory
506 seed
508 optimizer
510 candidate joint configuration
512 path planner
514 trajectory seed
516 candidate trajectory
518 trajectory optimization
602 collision detection method
604a block
604b block
604c block
606 sphere
608 motion path
610 distance
612 obstacle
614 backward midpoint
616 position
618 forward midpoint
802 register file
804 register collectors
806 selectors
1002 parallel processing unit
1004 I/O unit
1006 front-end unit
1008 scheduler unit
1010 work distribution unit
1012 hub
1014 crossbar
1016 NVLink
1018 interconnect
1020 memory
1100 general processing cluster
1102 pipeline manager
1104 pre-raster operations unit
1106 raster engine
1108 work distribution crossbar
1110 memory management unit
1112 data processing cluster
1114 primitive engine
1116 M-pipe controller
1200 memory partition unit
1202 raster operations unit
1204 level two cache
1206 memory interface
1300 streaming multiprocessor
1302 instruction cache
1304 scheduler unit
1306 register file
1308 core
1310 special function unit
1312 load/store unit
1314 interconnect network
1316 shared memory/L1 cache
1318 dispatch
1400 processing system
1402 central processing unit
1404 switch
1406 parallel processing module
1500 exemplary processing system
1502 communications bus
1504 main memory
1506 input devices
1508 display devices
1510 network interface
1600 graphics processing pipeline
1602 output data
1604 data assembly
1606 vertex shading
1608 primitive assembly
1610 geometry shading
1612 viewport SCC
1614 rasterization
1616 fragment shading
1618 raster operations
1620 input data

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A computer processor comprising:
a plurality of internal execution partitions, each execution partition configured to execute a plurality of threads in parallel;
the computer processor configured to:
receive an instruction from a thread executing in a particular one of the execution partitions, the instruction comprising a thread index, a register specifier, and a destination operand; and
return in the destination operand a value of a register associated with the register specifier from one of the plurality of threads executing in the particular one of the execution partitions, wherein the register is a local register of a thread identified by the thread index.

2. The computer processor of claim 1, wherein each execution partition is configured to execute up to eight threads in parallel.

3. The computer processor of claim 1, further comprising:
a plurality of register collectors each associated with one of the execution partitions.

4. A non-volatile computer-readable storage medium comprising an instruction that, when applied to a computer processor from a thread executing in particular one of a plurality of internal execution partitions of the computer processor, configures the computer processor to:
parse the instruction into a thread identifier, a register specifier, and a destination operand; and
return in the destination operand a value of a register associated with the register specifier from one of a plurality of threads executing in the particular one of the execution partitions, wherein the register is a local register of a thread identified by the thread identifier.

5. The non-volatile computer-readable storage medium of claim 4 further comprising instructions that, when applied to the computer processor, further configure the computer processor to:
apply the value of the register returned in the destination operand in a collision detection operation for a robotic manipulator.

6. The non-volatile computer-readable storage medium of claim 5 further comprising instructions that, when applied to the computer processor, further configure the computer processor to:
apply the value of the register returned in the destination operand as a sphere specification.

7. The non-volatile computer-readable storage medium of claim 4 further comprising instructions that, when applied to the computer processor, further configure the computer processor to:
apply the value of the register returned in the destination operand to detect a collision between two spheres.

8. The non-volatile computer-readable storage medium of claim 5 further comprising instructions that, when applied to the computer processor, further configure the computer processor to:
apply the value of the register returned in the destination operand in a distance calculation.

9. A computer processor configured to:
receive an instruction comprising a first operand, a second operand, and a destination operand;
the first operand comprising three parameters of a first object in FP8 format;
the second operand comprising three parameters of a second object in FP8 format; and
the computer processor configured to:
return in the destination operand a distance between the first object and the second object.

10. The computer processor of claim 9, wherein the first operand comprises a center point and radius of a first sphere and the second operand comprises a center point and radius of a second sphere, and the distance is between a surface of the first sphere and a surface of the second sphere.

11. The computer processor of claim 9, further configured to:
apply a RELU operation to the distance before returning it in the destination operand.

12. A non-volatile computer-readable storage medium comprising an instruction that configures a computer processor to:
parse the instruction into a first operand defining three parameters in FP8 format;
parse the instruction into a second operand defining three parameters in FP8 format; and
return in the destination operand a distance between a first object defined by the three parameters of the first operand and a second object defined by the three parameters of the second operand.

13. The non-volatile computer-readable storage medium of claim 12 wherein the first operand comprises a center point and radius of a first sphere and the second operand comprises a center point and radius of a second sphere.

14. The non-volatile computer-readable storage medium of claim 13 further comprising instructions that, when applied to the computer processor, further configure the computer processor to:
apply the distance returned in the destination operand in a collision detection operation for a robotic manipulator.

15. The non-volatile computer-readable storage medium of claim 13 further comprising instructions that, when applied to the computer processor, further configure the computer processor to:
apply the distance returned in the destination operand to detect a collision between the first sphere and the second sphere.

16. The non-volatile computer-readable storage medium of claim 12 wherein a third parameter of the first operand and a third parameter of the second operand are each set to zero.

17. The non-volatile computer-readable storage medium of claim 12 wherein the instruction, when applied to a computer processor, further configures the computer processor to:
parse the instruction into a third operand defining three parameters in FP8 format; and
return in the destination operand two distance values for two distinct pairings of the first object, the second object, and a third object defined by the three parameters of the third operand.

18. The non-volatile computer-readable storage medium of claim 12 wherein the instruction, when applied to a computer processor, further configures the computer processor to:
parse the instruction into a third operand defining three parameters in FP8 format; and
return in the destination operand three distance values for three distinct pairings of the first object, the second object, and a third object defined by the three parameters of the third operand.

19. A computer processor configured to:
receive an instruction comprising a first register specifier and a destination operand; and
return in the destination operand an index of a thread associated with a maximal or minimal value of a local register associated with the first register specifier.

20. The computer processor of claim 19, wherein the instruction further comprises a second register specifier, and the computer processor is further configured to:
return in the destination operand an index of a thread associated with a maximal or minimal value of a local register associated with the second register specifier.

21. The computer processor of claim 19, wherein the instruction further comprises a second register specifier, and the computer processor is further configured to:
return in the destination operand an index of a thread associated with a maximal or minimal value of local registers associated with both of the first register specifier and the second register specifier.

22. The computer processor of claim 19, wherein the index is scoped to a warp of threads.

23. The computer processor of claim 19, wherein the index is scoped to a subset of threads of a warp assigned to an execution partition of the computer processor.

24. The computer processor of claim 19, wherein the instruction further comprises a format specifier for values stored in local registers specified by the first register specifier.

25. A non-volatile computer-readable storage medium comprising an instruction that configures a computer processor to:
parse the instruction into a first register specifier and a destination operand; and
return in the destination operand an index of a thread associated with a maximal or minimal value of a local register associated with the first register specifier.

26. The non-volatile computer-readable storage medium of claim 25 further comprising instructions that, when applied to the computer processor, further configure the computer processor to:
apply the index returned in the destination operand in a collision detection operation for a robotic manipulator.

27. The non-volatile computer-readable storage medium of claim 26 further comprising instructions that, when applied to the computer processor, further configure the computer processor to:
apply the index returned in the destination operand to detect a collision between two spheres.

28. The non-volatile computer-readable storage medium of claim 25 wherein the instruction further comprises a second register specifier and, when applied to the computer processor, further configures the computer processor to:
return in the destination operand an index of a thread associated with a maximal or minimal value stored in a local register associated with the second register specifier.

29. The non-volatile computer-readable storage medium of claim 25 wherein the instruction further comprises a second register specifier and, when applied to the computer processor, further configures the computer processor to:
return in the destination operand an index of a thread associated with a maximal or minimal value stored in local registers associated with both of the first register specifier and the second register specifier.

30. The non-volatile computer-readable storage medium of claim 25, wherein the index is scoped to a warp of threads.

31. The non-volatile computer-readable storage medium of claim 25, wherein the index is scoped to a subset of threads of a warp assigned to an execution partition of the computer processor.

32. The non-volatile computer-readable storage medium of claim 25, wherein the instruction further comprises a format specifier for values stored in local registers specified by the first register specifier.
